(19) United States
(12) Patent Application Publication
(10) Pub. No.: US 2024/0222788 A1
(43) Pub. Date: Jul. 4, 2024

(54) BINDER DISPERSION FOR NON-AQUEOUS SECONDARY BATTERY SEPARATOR, SLURRY COMPOSITION, NON-AQUEOUS SECONDARY BATTERY SEPARATOR, AND NON-AQUEOUS SECONDARY BATTERY

(71) Applicants: artience Co., Ltd., Tokyo (JP); TOYOCHEM CO., LTD., Tokyo (JP)

(72) Inventors: Akiko IMAZATO, Chuo-ku, Tokyo (JP); Yoshiyuki SAKAI, Chuo-ku, Tokyo (JP); Takaaki KOIKE, Chuo-ku, Tokyo (JP); Airei CHOU, Chuo-ku, Tokyo (JP); Daisuke FUJIKAWA, Chuo-ku, Tokyo (JP)

(73) Assignees: artience Co., Ltd., Tokyo (JP); TOYOCHEM CO., LTD., Tokyo (JP)

(21) Appl. No.: 18/557,989

(22) PCT Filed: Mar. 23, 2022
(86) PCT No.: PCT/JP2022/013747

§ 371 Date: Oct. 30, 2023

(30) Foreign Application Priority Data
May 31, 2021 (JP) 2021-091136
Jan. 7, 2022 (JP) 2022-001818

(51) Int. Cl. H01M 50/42; C08F 220/28; C08F 220/56; C09D 7/45; C09D 133/14; C09D 133/26; H01M 50/449

(52) U.S. Cl. CPC H01M 50/42; C08F 220/281; C08F 220/56; C09D 7/45; C09D 133/14; C09D 133/26; H01M 50/449; C08F 2800/20

(57) ABSTRACT

A binder dispersion having excellent electrolytic solution resistance, a slurry composition having excellent solution stability and coatability, a separator being low in water content and having excellent heat resistance and adhesion to a separator substrate, and a non-aqueous secondary battery having low internal resistance and good cycle characteristics. An object thereof is to be attained by using a binder dispersion for a non-aqueous secondary battery separator, the binder dispersion including a polymer and an aqueous medium, in which the polymer has an acid value of 15 mgKOH/g or less and is an ethylenically unsaturated monomer mixture containing (meth)acrylamide and a nonionic ethylenically unsaturated monomer with a specific value for an octanol/water partition coefficient logarithm (Log Kow) at 25° C., and light transmittance at a wavelength of 400 nm is less than 70% under a condition of a solid concentration of 5% by mass.

### TECHNICAL FIELD

The present disclosure relates to a binder for a non-aqueous secondary battery separator that can be used to form a protective layer for a separator of a non-aqueous secondary battery such as a lithium ion secondary battery. The present disclosure also relates to a coating agent containing such a binder for a non-aqueous secondary battery separator, a non-aqueous secondary battery separator including a protective layer formed from the coating agent containing the binder for a non-aqueous secondary battery separator, and a non-aqueous secondary battery including the non-aqueous secondary battery separator.

### BACKGROUND

Non-aqueous secondary batteries are used in a wide range of applications because of their small size, lightweight, and high energy density as well as capability of repeated charge-discharge. A lithium-ion secondary battery, in particular, is used in a wide range of applications such as smartphones, tablets, laptops, and electric vehicles because of their high output power, resulting in a rapid increase in demand for the battery.

The lithium-ion secondary battery has an electrically insulating separator layer between electrodes to ensure safety under abnormal conditions. This separator has a porous structure that allows lithium ions to flow back and forth under normal conditions, but when an abnormal reaction occurs and causes a rise in temperature, pores are plugged to block lithium ions from flowing back and forth, thus playing a role in preventing short circuits in the battery. Such a separator is made of a polyolefin sheet, such as polyethylene and polypropylene, having a porous structure or a coated sheet based on these substrates with a protective layer formed by further applying a slurry composition containing non-conductive fine particles and a binder for the purpose of imparting heat resistance. In recent years, there has been a growing demand for thinner separators with a further increase in the capacity of batteries. Even in the above coated separator, the substrate has become thinner.

On the other hand, when the substrate is made thin, heat resistance and durability of the separator are more likely to decrease. Therefore, imparting excellent heat resistance and durability to such a separator has been studied in recent years. Japanese Unexamined Patent Application Publication No. 2020-24896 discloses a protective layer in which a water-soluble polymer obtained by polymerizing a (meth)acrylamide group-containing compound and a hydroxy group-containing (meth)acrylic ester is used as a binder for a separator. International Patent Publication No. WO 2017/026095 discloses a protective layer in which a water-soluble polymer containing 40% by mass or more of (meth)acrylamide and a particulate polymer are used as a binder for a separator. International Patent Publication No. WO 2019/065909 discloses a protective layer in which a polymer of an amide-group containing ethylenically unsaturated monomer, a carboxy group-containing ethylenically unsaturated monomer, and a carboxylic acid ester-containing ethylenically unsaturated monomer is used as a binder for a separator.

### SUMMARY

Although a separator binder using such a water-soluble resin is excellent in heat resistance and electrolytic solution resistance, an increase in viscosity may cause coating defect. When the separator binder was mixed with inorganic fine particles to form a slurry composition for a non-aqueous secondary battery separator, gaps between the inorganic fine particles may be filled, resulting in an increase in internal resistance. In addition, high water content in the separator and a reaction between a battery member and water cause degradation of cycle characteristics.

Therefore, an object of the present disclosure is to provide: a binder dispersion for a non-aqueous secondary battery separator, the binder dispersion having excellent electrolytic solution resistance; a slurry composition for a non-aqueous secondary battery separator, the slurry composition having excellent solution stability and coatability and containing the binder for a non-aqueous secondary battery separator; a non-aqueous secondary battery separator with a protective layer formed from the slurry composition for a non-aqueous secondary battery separator, the secondary battery separator being low in water content and having excellent heat resistance and adhesion to a separator substrate; and a non-aqueous secondary battery including the non-aqueous secondary battery separator, the non-aqueous secondary battery having low internal resistance and good cycle characteristics.

The present disclosure relates to a binder dispersion for a non-aqueous secondary battery separator, the binder dispersion including:
a polymer (A1); and an aqueous medium, in which
the polymer (A1) has an acid value of 15 mgKOH/g or less and is a polymer (A1a) of an ethylenically unsaturated monomer mixture containing 40 to 80% by mass of (meth)acrylamide and 20 to 60% by mass of a nonionic ethylenically unsaturated monomer (a-1a) having an octanol/water partition coefficient logarithm (Log Kow) of 0.25 to 1.5 at 25° C. based on a total mass of the ethylenically unsaturated monomer mixture, and
light transmittance at a wavelength of 400 nm is less than 70% under a condition of a solid concentration of 5% by mass.

The present disclosure relates to a binder dispersion for a non-aqueous secondary battery separator, the binder dispersion including:
a polymer (A1); a surfactant; and an aqueous medium, in which the polymer (A1) has an acid value of 15 mgKOH/g or less and is a polymer (A1b) of an ethylenically unsaturated monomer mixture containing 50 to 85% by mass of (meth)acrylamide and 15 to 50% by mass of a nonionic ethylenically unsaturated monomer (a-1b) having an octanol/water partition coefficient logarithm (Log Kow) of 1.9 to 4.2 at 25° C. based on a total mass of the ethylenically unsaturated monomer mixture, and light transmittance at a wavelength of 400 nm is less than 70% under a condition of a solid concentration of 5% by mass.

The present disclosure relates to the binder dispersion for a non-aqueous secondary battery separator, in which the polymer (A1) has a storage modulus of 1.0×10⁶ Pa or more at 150° C.

The present disclosure relates to the binder dispersion for a non-aqueous secondary battery separator, in which the polymer (A1) has an electrolytic solution swelling degree of less than 2 times when immersed in a mixed solvent of ethylene carbonate and diethyl carbonate in a volume ratio of 2:3 at 60° C. for 72 hours.

The present disclosure relates to the binder dispersion for a non-aqueous secondary battery separator, in which the binder dispersion has a viscosity of 2,500 mPa·s or more and less than 25,000 mPa·s at a solid concentration of 15% by mass.

The present disclosure relates to the binder dispersion for a non-aqueous secondary battery separator, in which the binder dispersion has a viscosity of 100 mPa·s or more and less than 15,000 mPa·s at a solid concentration of 15% by mass.

The present disclosure relates to a slurry composition for a non-aqueous secondary battery separator, the slurry composition including an inorganic fine particle and the binder dispersion for a non-aqueous secondary battery separator.

The present disclosure relates to the slurry composition for a non-aqueous secondary battery separator, the slurry composition further including a polymer (A2) but excluding the polymer (A1),
in which the polymer (A2) is a particulate polymer having a glass transition temperature of −40 to 40° C.

The present disclosure relates to a non-aqueous secondary battery separator including a protective layer formed from the slurry composition for a non-aqueous secondary battery separator on at least one surface of a separator substrate.

The present disclosure relates to a non-aqueous secondary battery including the non-aqueous secondary battery separator.

The present disclosure can provides: a binder dispersion for a non-aqueous secondary battery separator, the binder dispersion having excellent electrolytic solution resistance; a slurry composition for a non-aqueous secondary battery separator, the slurry composition having excellent solution stability and coatability and including the binder for a non-aqueous secondary battery separator; a non-aqueous secondary battery separator with a protective layer formed from the slurry composition for a non-aqueous secondary battery separator, the secondary battery separator having excellent heat resistance and adhesion to a separator substrate; and a non-aqueous secondary battery including the non-aqueous secondary battery separator, the non-aqueous secondary battery having low internal resistance and good cycle characteristics.

### DETAILED DESCRIPTION OF EMBODIMENTS

Hereinafter, the binder dispersion for a non-aqueous secondary battery separator, the slurry composition for a non-aqueous secondary battery separator, the non-aqueous secondary battery separator, and the non-aqueous secondary battery of the present disclosure will be described based on preferred embodiments.

However, the present disclosure is not limited thereto. Each constitution can be replaced with any one that can exhibit a similar function, or an arbitrary constitution can be added.

In the present specification, when a range of numerical values is specified by using the word “to”, the values written in front and behind the “to” are also included as the lower-limit value and the upper-limit value of the range. In this specification, the terms “film” and “sheet” are not differentiated according to the thickness.

Unless otherwise specified, the terms “(meth)acrylamide” and “(meth)acrylate” as used herein refer to “acrylamide or methacrylamide” and “acrylate or methacrylate”, respectively.

In addition, the term “ethylenically unsaturated monomer” means a monomer having an ethylenically unsaturated double bond, and the ethylenically unsaturated monomer is classified into (meth)acrylamide, a nonionic ethylenically unsaturated monomer (a-1a) having an octanol/water partition coefficient logarithm (Log Kow) of 0.25 to 1.5 at 25° C., a nonionic ethylenically unsaturated monomer (a-1b) having a Log Kow of 1.9 to 4.2, and another ethylenically unsaturated monomer (a-2) capable of polymerizing with the monomer (a-1a) or the monomer (a-1b).

As used herein, the terms “nonionic ethylenically unsaturated monomer (a-1a) having an octanol/water partition coefficient logarithm (Log Kow) of 0.25 to 1.5 at 25° C.”, “nonionic ethylenically unsaturated monomer (a-1b) having a Log Kow of 1.9 to 4.2”, “binder dispersion for a non-aqueous secondary battery separator”, and “slurry composition for a non-aqueous secondary battery separator” are sometimes abbreviated as the monomer (a-1a), the monomer (a-1b), the binder dispersion, and the slurry composition, respectively. In addition, the monomer (a-1a) and the monomer (a-1b) are sometimes collectively referred to as the monomer (a-1).

The polymer (A1a) and the polymer (A1b) are sometimes collectively referred to as the polymer (A1).

Note that each of various components mentioned in the present specification may be used alone or in combination of two or more thereof, unless otherwise noted.

The non-aqueous secondary battery refers to a secondary battery that does not use water as an electrolytic solution, and examples thereof include a lithium ion secondary battery (LIB), a sodium ion secondary battery, and a magnesium secondary battery. The LIB will be described herein as an example of a non-aqueous secondary battery, but of course the binder dispersion for a non-aqueous secondary battery separator, the slurry composition for a non-aqueous secondary battery separator, and the non-aqueous secondary battery separator of the present disclosure can be applied to a non-aqueous secondary battery other than the LIB.

### <<Binder Dispersion for Non-aqueous Secondary Battery Separator>>

The binder dispersion for a non-aqueous secondary battery separator according to a first embodiment includes a polymer (A1) and an aqueous medium, in which
the polymer (A1) has an acid value of 15 mgKOH/g or less and is a polymer (A1a) of an ethylenically unsaturated monomer mixture containing 40 to 80% by mass of (meth)acrylamide and 20 to 60% by mass of a nonionic ethylenically unsaturated monomer (a-1a) having an octanol/water partition coefficient logarithm (Log Kow) of 0.25 to 1.5 at 25° C. based on a total mass of the ethylenically unsaturated monomer mixture, and
light transmittance at a wavelength of 400 nm is less than 70% under a condition of a solid concentration of 5% by mass.

The binder dispersion for a non-aqueous secondary battery separator according to a second embodiment includes a polymer (A1), a surfactant, and an aqueous medium, in which the polymer (A1) has an acid value of 15 mgKOH/g or less and is a polymer (A1b) of an ethylenically unsaturated monomer mixture containing 50 to 85% by mass of (meth)acrylamide and 15 to 50% by mass of a nonionic ethylenically unsaturated monomer (a-1b) having an octanol/water partition coefficient logarithm (Log Kow) of 1.9 to 4.2 at 25° C. based on a total mass of the ethylenically unsaturated monomer mixture, and light transmittance at a wavelength of 400 nm is less than 70% under a condition of a solid concentration of 5% by mass.

The constitutions of the first embodiment or the second embodiment enable the binder dispersion for a non-aqueous secondary battery separator to have excellent electrolytic solution resistance, and a slurry composition using the same has excellent solution stability and coatability.

### <Aqueous Medium>

The term “aqueous medium” herein refers to an aqueous dispersion medium or an aqueous solvent.

The aqueous medium to be used is preferably water, but, if necessary, a water-soluble solvent can be used. Examples of the water-soluble solvent include alcohols, glycols, cellosolves, amino alcohols, amines, ketones, carboxylic acid amides, phosphoric acid amides, sulfoxides, carboxylic acid esters, phosphoric acid esters, ethers, and nitriles.

### <Surfactant>

Examples of the surfactant include an anionic surfactant, a cationic surfactant, and a nonionic surfactant. The anionic surfactant or the nonionic surfactant is preferred.

When containing the surfactant, the polymer (A1) can be stably dispersed in the aqueous medium, and a slurry composition using the same can have excellent solution stability.

The surfactant is contained in an amount of preferably 0.05 to 2.0 parts by mass and more preferably 0.05 to 0.5 parts by mass per 100 parts by mass of the polymer (A1), whereby the polymerization stability of the polymer (A1) in an aqueous medium is further improved.

Examples of the anionic surfactant include higher fatty acid salts such as sodium oleate, alkylaryl sulfonates such as dodecylbenzene sulfonate, alkyl sulfate ester salts such as sodium lauryl sulfate, polyoxyethylene alkyl ether sulfate ester salts such as sodium polyoxyethylene lauryl ether sulfate, alkyl sulfosuccinate ester salts such as sodium monooctyl sulfosuccinate, sodium dioctyl sulfosuccinate, and sodium polyoxyethylene lauryl sulfosuccinate and derivatives thereof, and polyoxyethylene distyreneated phenyl ether sulfate ester salts. However, among them, the surfactant is preferably an alkyl sulfate ester salt or an alkyl sulfosuccinate ester salt, and more preferably, the alkyl sulfate ester salt is lauryl sulfate while the alkyl sulfosuccinate ester salt is dioctyl sulfosuccinate, from the viewpoint of less adverse effect on corrosion resistance (seasoning resistance and microwave resistance) of the food packaging sheet.

Examples of the nonionic surfactant include polyoxyethylene alkyl ethers, such as polyoxyethylene lauryl ether and polyoxyethylene stearyl ether; polyoxyethylene alkyl phenyl ethers, such as polyoxyethylene octylphenyl ether and polyoxyethylene nonylphenyl ether; sorbitan higher fatty acid esters, such as sorbitan monolaurate, sorbitan monostearate, and sorbitan trioleate; polyoxyethylene sorbitan higher fatty acid esters, such as polyoxyethylene sorbitan monolaurate and polyoxyethylene sorbitan monostearate; polyoxyethylene higher fatty acid esters, such as polyoxyethylene monolaurate and polyoxyethylene monostearate; glycerin higher fatty acid esters, such as oleic acid monoglyceride and stearic acid monoglyceride; polyoxyethylene-polyoxypropylene block copolymers; polyvinyl alcohol; polyvinylpyrrolidone; and polyoxyethylene distyreneated phenyl ether.

The surfactant available is also a polymerizable surfactant having one or more radically polymerizable unsaturated double bonds (vinyl group and (meth)acryloyl group) in the molecule.

Examples of such polymerizable anionic surfactant include surfactants having a main skeleton of sulfosuccinic acid ester, alkyl ether, alkyl phenyl ether, alkyl phenyl ester, (meth)acrylate sulfate ester, and phosphate ester. Examples of such a polymerizable nonionic surfactant include surfactants having a main skeleton of alkyl ether, alkyl phenyl ether, and alkyl phenyl ester.

### <Polymer (A1)>

The polymer (A1) according to the first embodiment has an acid value of 15 mgKOH/g or less and is a polymer (A1a) of an ethylenically unsaturated monomer mixture containing 40 to 80% by mass of (meth)acrylamide and 20 to 60% by mass of a nonionic ethylenically unsaturated monomer (a-1a) having an octanol/water partition coefficient logarithm (Log Kow) of 0.25 to 1.5 at 25° C. based on a total mass of the ethylenically unsaturated monomer mixture.

The polymer (A1) according to the second embodiment has an acid value of 15 mgKOH/g or less and is a polymer (A1b) of an ethylenically unsaturated monomer mixture containing 50 to 85% by mass of (meth)acrylamide and 15 to 50% by mass of a nonionic ethylenically unsaturated monomer (a-1b) having an octanol/water partition coefficient logarithm (Log Kow) of 1.9 to 4.2 at 25° C. based on a total mass of the ethylenically unsaturated monomer mixture.

The ethylenically unsaturated monomer mixture (a-1) in both cases may contain another ethylenically unsaturated monomer (a-2), if necessary.

In the present specification, a polymer satisfying the aforementioned requirements is defined as the polymer (A1), even if its glass transition temperature (Tg) is −40 to 40° C.

The acid value of the polymer (A1) is 15 mgKOH/g or less and more preferably 10 mgKOH/g or less. When the acid value is in the above range, the solution stability of the slurry composition becomes better in the case where the slurry composition for a non-aqueous secondary battery separator is prepared by blending the polymer (A1) with an inorganic fine particle.

Hereinafter, the polymer (A1a) according to the first embodiment and the polymer (A1b) according to the second embodiment will each be described in turn.

### (Polymer (A1a))

### [(Meth)Acrylamide]

The polymer (A1a) contains (meth)acrylamide in an amount of 40 to 80% by mass and preferably 45 to 75% by mass based on the total mass (100% by mass) of the ethylenically unsaturated monomer mixture. When the content is in the above range, the electrolytic solution resistance and heat resistance can be significantly improved. The affinity with an inorganic fine particle is improved in the case where the slurry composition for a non-aqueous secondary battery separator is prepared by blending the polymer (A1a) with the inorganic fine particle, thereby improving the solution stability of the slurry composition.

[Nonionic Ethylenically Unsaturated Monomer (a-1a)]

The nonionic ethylenically unsaturated monomer (a-1a) is an ethylenically unsaturated monomer in which the octanol/water partition coefficient logarithm (Log Kow) is 0.25 to 1.5 and preferably 0.3 to 1.3.

With the Log Kow of 0.25 or more, the polymer (A1a) becomes a dispersed system in an aqueous medium and does not fill the gaps between the inorganic fine particles when formed into the slurry composition, resulting in good ion permeability of the separator. Thus, the battery performance in terms of internal resistance and cycle characteristics is improved. Since the increase in viscosity is suppressed even when the molecular weight of the binder is increased due to the good heat resistance and adhesion of the separator, the slurry composition also has excellent coatability. Since the polymerization stability with (meth)acrylamide in an aqueous medium is good when the Log Kow is 1.5 or less, the slurry composition also has excellent stability.

The nonionic ethylenically unsaturated monomer (a-1a) is contained in an amount of 20 to 60% by mass and preferably 23 to 55% by mass based on the total mass (100% by mass) of the ethylenically unsaturated monomer mixture. Since the polymerization stability with (meth)acrylamide in an aqueous medium is good when the content is in the above range, the polymer (A1a) can be stably dispersed in the aqueous medium, thereby decreasing internal resistance of the battery. In addition, the increase in viscosity is also suppressed even when the molecular weight of the polymer (A1a) is large, and both the heat resistance and the coatability can be achieved.

Note that the nonionic ethylenically unsaturated monomer refers to an ethylenically unsaturated monomer having no charged functionality in an aqueous medium, and is, for example, an ethylenically unsaturated monomer having no amino group, carboxyl group, or sulfonyl group.

Examples of the nonionic ethylenically unsaturated monomer (a-1a) having an octanol-water partition coefficient logarithm (Log Kow) of 0.25 to 1.5 include methyl acrylate (Log Kow=0.59), methoxyethyl methacrylate (Log Kow=0.81), 2-hydroxyethyl methacrylate (Log Kow=0.33), 4-hydroxybutyl acrylate (Log Kow=0.90), isopropylacrylamide (Log Kow=0.96), diacetoneacrylamide (Log Kow=0.82), 2-acetoacetoxyethyl methacrylate (Log Kow=0.59), glycidyl methacrylate (Log Kow=0.59), methyl methacrylate (Log Kow=1.13), ethyl acrylate (Log Kow=1.08), and trifluoroethyl acrylate (Log Kow=1.41), among which 2-hydroxyethyl methacrylate or methyl methacrylate is preferred because of good polymerization stability in an aqueous medium with (meth)acrylamide and dispersibility of the polymer (A1a).

The octanol/water partition coefficient (Log Kow), expressed by (Equation 1) below, is used as an index indicating whether a given compound X partitions readily into an aqueous phase or oil phase (octanol). The Log Kow of each ethylenically unsaturated monomer can be calculated from experiments through, for example, a shake-flask method and an HPLC method, or can be done from simulations based on chemical structures through, for example, a YMB method (physical property prediction function) of the Hansen solubility parameter software HSPiP.

$$Log Kow = Log ( concentration of compound X in octanol \text{phase/concentration} of compound X in aqueous phase ) \qquad ( Equation 1 )$$

[Another Ethylenically Unsaturated Monomer (a-2)]

Another ethylenically unsaturated monomer (a-2) is an ethylenically unsaturated monomer other than (meth)acrylamide and the nonionic ethylenically unsaturated monomer (a-1) and is polymerizable with (meth)acrylamide and the nonionic ethylene unsaturated monomer (a-1).

Examples of the ethylenically unsaturated monomer (a-2) include aromatic ethylenically unsaturated compounds, such as vinylnaphthalene and phenoxyhexaethylene glycol methacrylate;
linear or branched alkyl group-containing ethylenically unsaturated monomers, such as ethyl (meth)acrylate, propyl acrylate, 2-ethylhexyl methacrylate, octyl methacrylate, nonyl (meth)acrylate, decyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, stearyl (meth)acrylate, isostearyl (meth)acrylate, and behenyl (meth)acrylate;
fluorinated alkyl group-containing ethylenically unsaturated monomers, such as trifluoroethyl (meth)acrylate and heptadecafluorodecyl (meth)acrylate;
carboxyl group-containing ethylenically unsaturated monomers, such as maleic acid (anhydride), fumaric acid, itaconic acid, citraconic acid, or alkyl or alkenyl monoester thereof, β-(meth)acryloxyethyl succinate monoester, (meth)acrylic acid, crotonic acid, and cinnamic acid;
sulfo group-containing ethylenically unsaturated monomers, such as 2-acrylamide 2-methylpropanesulfonic acid, methallyl sulfonic acid, allyl sulfonic acid, and vinyl sulfonic acid, and salts thereof;
amide group-containing ethylenically unsaturated monomers, such as N-methoxymethyl-(meth)acrylamide, N-ethoxymethyl-(meth)acrylamide, N-propoxymethyl-(meth)acrylamide, N-butoxymethyl-(meth)acrylamide, N,N-di(methoxymethyl) (meth)acrylamide, N-ethoxymethyl-N-methoxymethyl (meth)acrylamide, N,N-di(ethoxymethyl) (meth)acrylamide, N,N-dimethyl (meth)acrylamide, N,N-diethyl (meth)acrylamide, and diacetone (meth)acrylamide; hydroxyl group-containing ethylenically unsaturated monomers such as 2-hydroxyethyl (meth)acrylate, 2-hydroxypropyl (meth)acrylate, 4-hydroxybutyl (meth)acrylate, glycerol mono (meth)acrylate, and allyl alcohol;
polyoxyethylene group-containing ethylenically unsaturated monomers, such as methoxypolyethylene glycol (meth)acrylate and polyethylene glycol (meth)acrylate;
dimethylaminoethyl (meth)acrylate, diethylaminoethyl (meth)acrylate, methylethylaminoethyl (meth)acrylate, dimethylaminostyrene, and diethylaminostyrene. Another examples thereof include: amino group-containing ethylenically unsaturated monomers, such as dimethylaminoethyl (meth)acrylate, diethylaminoethyl (meth)acrylate, methylethylaminoethyl (meth)acrylate, tetramethylpiperidyl (meth)acrylate, pentamethylpiperidyl methacrylate, N,N-dimethylaminopropyl (meth)acrylamide, and N, N-diethylaminopropyl (meth)acrylamide;
epoxy group-containing ethylenically unsaturated monomers, such as glycidyl (meth)acrylate and 3,4-epoxycyclohexylmethyl (meth)acrylate; ketone group-containing ethylenically unsaturated monomers, such as acetoacetoxy (meth)acrylate;
ethylenically unsaturated monomers having two or more ethylenically unsaturated groups, such as allyl acrylate, 1-methylallyl acrylate, diallyl phthalate, 3-butenyl acrylate, ethylene glycol diacrylate, triethylene glycol di(meth)acrylate, tetraethylene glycol di(meth)acrylate, trimethylolpropane tri(meth)acrylate, pentaerythritol tri (meth)acrylate, and diallyl maleate; alkoxysilyl group-containing ethylenically unsaturated monomers, such as γ-methacryloxypropyltributoxysilane, γ-acryloxymethyltrimethoxysilane, vinyltrimethoxysilane, vinyltributoxysilane, and vinylmethyldimethoxysilane; and
methylol group-containing ethylenically unsaturated monomers, such as N-methylol (meth)acrylamide, N,N-dimethylol (meth)acrylamide, and alkyl-etherified N-methylol (meth)acrylamide.

In the polymer (A1a), the other ethylenically unsaturated monomer (a-2) is preferably butyl acrylate, styrene, or acrylic acid from the viewpoint of polymerization stability of the (meth)acryl amide and the nonionic ethylenically unsaturated monomer (a-1) in an aqueous medium and good affinity with inorganic fine particles in the form of a slurry composition.

When the other ethylenically unsaturated monomer (a-2) is used in combination, the content of the other ethylenically unsaturated monomer (a-2) is preferably 5% by mass or less based on the total mass (100% by mass) of the ethylenically unsaturated monomer mixture as a range that does not impair the effect of the present invention.

### (Polymer (A1b))

### [(Meth)acrylamide]

The polymer (A1b) contains (meth)acrylamide in an amount of 50 to 85% by mass and preferably 60 to 80% by mass based on the total mass (100% by mass) of the ethylenically unsaturated monomer. When the content is in the above range, the electrolytic solution resistance and heat resistance can be significantly improved. The affinity with an inorganic fine particle is improved in the case where the slurry composition for a non-aqueous secondary battery separator is prepared by blending the polymer (A1a) with the inorganic fine particle, thereby improving the solution stability of the slurry composition.

[Nonionic Ethylenically Unsaturated Monomer (a-1b)]

The nonionic ethylenically unsaturated monomer (a-1b) is an ethylenically unsaturated monomer in which the octanol/water partition coefficient logarithm (Log Kow) is 1.9 to 4.2, preferably 2.0 to 4.2, and more preferably 2.2 to 3.5.

With the Log Kow of 1.9 or more, the polymer (A1b) becomes a dispersed system in an aqueous medium and does not fill the gaps between the inorganic fine particles when formed into the slurry composition, resulting in good ion permeability of the separator. Thus, the battery performance in terms of internal resistance and cycle characteristics is improved. Since the increase in viscosity is suppressed even when the molecular weight of the binder is increased due to the good heat resistance and adhesion of the separator, the slurry composition also has excellent coatability. In addition, the water content of the separator is reduced, resulting in excellent cycle characteristics. Furthermore, when the Log Kow is 4.2 or less, the nonionic ethylenically unsaturated monomer (a-1b) is more uniformly incorporated, resulting in excellent adhesion and heat resistance.

Note that the nonionic ethylenically unsaturated monomer refers to an ethylenically unsaturated monomer having no charged functionality in an aqueous medium, and is, for example, an ethylenically unsaturated monomer having no amino group, carboxy group, or sulfo group.

The nonionic ethylenically unsaturated monomer (a-1b) preferably does not have a crosslinkable functional group, that is, is preferably not a monomer having a crosslinkable functional group.

The crosslinkable functional group refers to a functional group that imparts a crosslinked structure to a side chain of a polymer, and examples thereof include a glycidyl group, an alkoxysilyl group, and an ethylenically unsaturated group.

Examples of the monomer having a crosslinkable functional group include a monomer having a glycidyl group, a monomer having an alkoxysilyl group, and a monomer having two or more ethylenically unsaturated bond groups.

The content of the nonionic ethylenically unsaturated monomer (a-1b) is 15 to 50% by mass and preferably 20 to 40% by mass based on the total mass (100% by mass) of the ethylenically unsaturated monomer. When the content of the ethylenically unsaturated monomer is 15% by mass or more, the water content of the separator can be reduced, resulting in excellent cycle characteristics. Since the increase in viscosity is suppressed, the slurry composition also has excellent coatability. Furthermore, when the content of the ethylenically unsaturated monomer is 50% by mass or less, both the adhesion and heat resistance of the separator can be achieved.

Examples of the nonionic ethylenically unsaturated monomer (a-1b) having an octanol/water partition coefficient logarithm (Log Kow) of 1.9 to 4.2 include: linear or branched alkyl group-containing ethylenically unsaturated monomers, such as t-butyl acrylate (Log Kow=2.06), isobutyl acrylate (Log Kow=2.09), butyl acrylate (Log Kow=2.23), propyl methacrylate (Log Kow=2.28), t-butyl methacrylate (Log Kow=2.67), pentyl acrylate (Log Kow=2.70), butyl methacrylate (Log Kow=2.84), pentyl methacrylate (Log Kow=3.03), hexyl acrylate (Log Kow=3.11), hexyl methacrylate (Log Kow=3.50), heptyl acrylate (Log Kow=3.62), 2-ethylhexyl acrylate (Log Kow=4.01), heptyl methacrylate (Log Kow=4.01), and octyl acrylate (Log Kow=4.20);
aromatic ethylenically unsaturated monomers, such as phenyl acrylate (Log Kow=1.97), benzyl acrylate (Log Kow=2.32), phenoxyethyl acrylate (Log Kow=2.44), phenoxydiethylene glycol acrylate (Log Kow=2.44), phenyl methacrylate (Log Kow=2.57), styrene (Log Kow=2.71), benzyl methacrylate (Log Kow=2.91), phenoxyethyl methacrylate (Log Kow=3.02), phenoxydiethylene glycol methacrylate (Log Kow=3.02), phenoxytetraethylene glycol acrylate (Log Kow=3.38), o-methylstyrene (Log Kow=3.40), a-methylstyrene (Log Kow=3.46), m-methylstyrene (Log Kow=3.46), p-methylstyrene (Log Kow=3.61), phenoxytetraethylene glycol methacrylate (Log Kow=3.96), and phenoxyhexaethylene glycol acrylate (Log Kow=4.15);
cycloalkyl group-containing ethylenically unsaturated monomers, such as dicyclopentenyloxyethyl acrylate (Log Kow=2.57), cyclohexyl acrylate (Log Kow=2.62), dicyclopentenyl acrylate (Log Kow=2.98), cyclohexyl methacrylate (Log Kow=3.06), dicyclopentanyl acrylate (Log Kow=3.29), dicyclopentenyl methacrylate (Log Kow=3.41), dicyclopentanyl methacrylate (Log Kow=3.73), isobornyl acrylate (Log Kow=3.78), and isobornyl methacrylate (Log Kow=4.20);
hydroxyl group-containing ethylenically unsaturated monomers, such as 4-hydroxyvinylbenzene (Log Kow=2.28);
amide group-containing ethylenically unsaturated monomers, such as N-pentoxymethyl-acrylamide (Log Kow=1.90), N, N-di(propoxymethyl) acrylamide (Log Kow=1.90), N-pentoxymethyl-methacrylamide (Log Kow=2.29), N,N-di(propoxymethyl) methacrylamide (Log Kow=2.29), N,N-di(butoxymethyl) acrylamide (Log Kow=3.12), and N,N-di(butoxymethyl) methacrylamide (Log Kow=3.51);
ethylenically unsaturated monomers having two or more ethylenically unsaturated groups, such as 2-butenyl acrylate (Log Kow=1.91), 1-butenyl acrylate (Log Kow=1.94), ethylene glycol dimethacrylate (Log Kow=2.07), allyl methacrylate (Log Kow=2.10), 2-methylallyl acrylate (Log Kow=2.10), divinyl adipate (Log Kow=2.12), 1,4-butanediol diacrylate (Log Kow=2.12), diallyl itaconate (Log Kow=2.19), 1-methylallyl methacrylate (Log Kow=2.50), diallyl isophtalate (Log Kow=2.51), 3-butenyl methacrylate (Log Kow=2.53), 2-butenyl methacrylate (Log Kow=2.60), 1,3-methyl-3-butenyl acrylate (Log Kow=2.62), 1-butenyl methacrylate (Log Kow=2.63), 2-methylallyl methacrylate (Log Kow=2.71), 1,4-butanediol dimethacrylate (Log Kow=2.98), diallyl phthalate (Log Kow=3.00), 1,3-methyl-3-butenyl methacrylate (Log Kow=3.01), and divinylbenzene (Log Kow=3.93);
alkoxysilyl group-containing ethylenically unsaturated monomers, such as γ-methacryloxymethyltrimethoxysilane (Log Kow=1.90), γ-methacryloxypropyltrimethoxysilane (Log Kow=2.42), γ-acryloxypropylmethyldimethoxysilane (Log Kow=2.47), γ-methacryloxypropylmethyldimethoxysilane (Log Kow=2.82), vinyltriethoxysilane (Log Kow=3.12), γ-acryloxypropyltrimethoxysilane (Log Kow=3.50), γ-acryloxypropyltriethoxysilane (Log Kow=3.50), γ-methacryloxypropylmethyldiethoxysilane (Log Kow=3.76), and γ-methacryloxypropyltriethoxysilane (Log Kow=3.86). Among them, a linear or branched alkyl group-containing ethylenically unsaturated monomer or an aromatic ethylenically unsaturated monomer is preferred, and butyl (meth)acrylate or styrene is particularly preferred because of good polymerization stability with (meth)acrylamide in an aqueous medium and good dispersibility of the polymer (A).
   [Another Ethylenically Unsaturated Monomer (a-2)]

Another ethylenically unsaturated monomer (a-2) is the same as the aforementioned polymer (A1a).

In the polymer (A1b), the other ethylenically unsaturated monomer (a-2) is preferably methyl (meth)acrylate, hydroxyethyl (meth)acrylate, or (meth)acrylic acid from the viewpoint of polymerization stability of the (meth)acryl amide and the nonionic ethylenically unsaturated monomer (a-1) in an aqueous medium and good affinity with inorganic fine particles in the form of a slurry composition.

When the other ethylenically unsaturated monomer (a-2) is used in combination, the content of the other ethylenically unsaturated monomer (a-2) is preferably 5% by mass or less based on the total mass (100% by mass) of the ethylenically unsaturated monomers as a range that does not impair the effect of the present disclosure.

### [Method for Manufacturing Polymer (A1)]

A method of polymerizing the ethylenically unsaturated monomer to manufacture the polymer (A1) may be any one of solution polymerization, suspension polymerization, bulk polymerization, emulsion polymerization, and the like.

The surfactant is preferably used together with the ethylenically unsaturated monomer mixture during the polymerization of the polymer (A1). The polymerization stability of (meth)acrylamide and the nonionic ethylenically unsaturated monomer (a-1) in an aqueous medium is excellent when the surfactant is used during the polymerization.

The solid concentration of the polymer (A1) in the binder dispersion is not particularly limited but is preferably 7% by mass to 50% by mass.

A radical polymerization initiator used in the polymerization can be any known oil-soluble polymerization initiator or water-soluble polymerization initiator.

The radical polymerization initiator is used in an amount of preferably 0.1 to 1.0 parts by mass and more preferably 0.1 to 0.5 parts by mass per 100 parts by mass of the ethylenically unsaturated monomer mixture. Since the viscosity of the binder dispersion can be adjusted within an appropriate range when the content is in the above range, it has excellent heat resistance, adhesion, and coatability.

Examples of the oil-soluble polymerization initiator include, but are not particularly limited to, an organic peroxide such as benzoyl peroxide, tert-butyl peroxybenzoate, tert-butyl hydroperoxide, tert-butyl peroxy (2-ethylhexanoate), tert-butyl peroxy-3,5,5-trimethylhexanoate, and di-tert-butyl peroxide; and an azobis compound such as 2,2′-azobisisobutyronitrile, 2,2′-azobis-2,4-dimethylvaleronitrile, 2,2′-azobis(4-methoxy-2,4-dimethylvaleronitrile), and 1,1′-azobis-cyclohexane-1-carbonitrile.

In the polymerization, the water-soluble polymerization initiator is preferably used, and examples of the water-soluble polymerization initiator that can be suitably used include conventionally known compounds such as ammonium persulfate (APS), potassium persulfate (KPS), hydrogen peroxide, and 2,2′-azobis(2-methylpropionamidine) dihydrochloride.

In the polymerization, a reducing agent may be used in combination with the polymerization initiator. The combined use of the reducing agent facilitates acceleration of an emulsion polymerization rate and polymerization at a low temperature. Examples of the reducing agent include reducing organic compounds such as metallic salts of ascorbic acid, erythorbic acid, tartaric acid, citric acid, glucose, and formaldehyde sulfoxylate; reducing inorganic compounds such as sodium thiosulfate, sodium sulfite, sodium hydrogen sulfite, and sodium metabisulfite; and ferrous chloride, rongalite, and thiourea dioxide.

The reducing agent is preferably used in an amount of 0.05 to 4 parts by mass per 100 parts by mass of the ethylenically unsaturated monomer.

In the polymerization of the ethylenically unsaturated monomer, a buffer, a chain transfer agent, a basic compound, or the like may be used, if necessary.

Examples of the buffer include sodium acetate, sodium citrate, and sodium bicarbonate.

Examples of the chain transfer agent include n-octyl mercaptan, t-octyl mercaptan, n-nonyl mercaptan, t-nonyl mercaptan, n-decyl mercaptan, t-decyl mercaptan, n-undecyl mercaptan, t-undecyl mercaptan, n-dodecyl mercaptan, t-dodecyl mercaptan, n-tridecyl mercaptan, t-tridecyl mercaptan, n-tetradecyl mercaptan, t-tetradecyl mercaptan, n-heptadecyl mercaptan, t-heptadecyl mercaptan, t-hexadecyl mercaptan, and n-hexadecyl mercaptan.

The basic compound is used for neutralization. Examples of the basic compound include alkylamines such as trimethylamine, triethylamine, and butylamine; alcohol amines such as 2-dimethylaminoethanol, 2-diethylaminoethanol, diethanolamine, triethanolamine, and aminomethyl propanol; morpholine; and ammonia.

### <Optional Component>

The binder dispersion of the present disclosure may contain various additives such as an antifoaming agent, a leveling agent, an antiseptic, a solvent, a cross-linking agent, a dispersant, and a binding agent as other optional components within a range that does not hinder the effect.

The storage modulus at 150° C. of the polymer (A1) is preferably 1.0×10⁶ Pa or more and less than 1.0×10¹⁰ Pa, and more preferably 1.0×10⁷ Pa or more. The storage modulus at 150° C. in the above range is preferred because the separator using the polymer (A1) has excellent heat resistance and shrinkage of the separator in a high temperature range is suppressed, thereby preventing a short circuit of the non-aqueous secondary battery.

The polymer (A1) preferably has an electrolytic solution swelling degree of less than 2 times, more preferably less than 1.5 times, when immersed in a mixed solvent of ethylene carbonate and diethyl carbonate in a volume ratio of 2:3 at 60° C. for 72 hours. An electrolytic solution swelling degree of less than two times is preferred because the swelling of the binder does not hinder conductivity of lithium ions, thereby preventing an increase in internal resistance.

The binder dispersion for a non-aqueous secondary battery separator of the present disclosure has a light transmittance of less than 70%, preferably less than 50%, under a condition of a solid concentration of 5% by mass at a wavelength of 400 nm. The dispersibility of the binder in the aqueous medium is sufficiently ensured within the above range. In the case of the slurry composition, gaps between the inorganic fine particles are not filled, resulting in good ion permeability of the separator. Thus, the battery performance in terms of internal resistance and cycle characteristics is improved. Since the increase in viscosity is suppressed even when the molecular weight of the binder is increased, the slurry composition also has excellent coatability.

The light transmittance can be determined by a ratio of light (1) transmitted through a sample to light (lo) incident on the sample when a light source is spectrally separated to the measurement wavelength with a diffraction grating, and is expressed by the following equation (2):

$$Transmittance ( \% ) = ( 1 / {1}_{0} ) \times 100 \qquad ( Equation 2 )$$

In the binder dispersion for a non-aqueous secondary battery separator of the present disclosure, the polymer (A1) is in the form of particles and has an average particle size of preferably 10 to 4,000 nm and more preferably 100 to 3,000 nm under a condition of a solid concentration of 1% by mass. Within the above range, the binder dispersion has good coatability and does not fill the gaps between the inorganic fine particles when blended with inorganic particles and used as a slurry composition for a non-aqueous secondary battery separator, thereby preventing an increase in the internal resistance of the non-aqueous secondary battery. It is also preferred because the increase in viscosity is also suppressed even when the molecular weight is large, and both the heat resistance and the coatability can be achieved.

The average particle size can be determined by diluting the binder dispersion with water to a solid concentration of 1% by mass, and measuring about 5 ml of the diluted solution by, for example, dynamic light scattering measurement (measurement device: Nanotrac UPA, manufactured by MicrotracBEL Corp., etc.). The peak of the volume particle size distribution data (histogram) obtained at this time is used as the average particle size.

The mPa·s of the binder dispersion for a non-aqueous secondary battery separator according to the first embodiment under the condition of a solid concentration of 15% by mass is preferably 2,500 or more and less than 25,000 mPa·s, and more preferably 3,000 mPa·s or more and less than 20,000 mPa·s. Within the above range, the binder dispersion has a molecular weight sufficient to exhibit heat resistance and adhesion, and the slurry composition has excellent solution stability and coatability.

The viscosity of the binder dispersion for a non-aqueous secondary battery separator according to the second embodiment under the condition of a solid concentration of 15% by mass is preferably 100 mPa·s or more and less than 15,000 mPa·s, and more preferably 500 mPa·s or more and less than 7,000 mPa·s. Within the above range, the binder dispersion has a molecular weight sufficient to exhibit heat resistance and adhesion, and the slurry composition has excellent solution stability and coatability.

In other words, the binder dispersion of the present disclosure can suppress interaction between resins when being a particulate polymer and has excellent handling properties, such as coatability, while having a high molecular weight.

The viscosity can be determined using a B-type viscometer at 25° C. and rotation speed of 20 rpm for a rotation time of 60 seconds.

### <<Slurry Composition for Non-Aqueous Secondary Battery Separator>>

The slurry composition for a non-aqueous secondary battery separator is used to form a protective layer for use in a non-aqueous secondary battery separator and contains at least the binder dispersion for a non-aqueous secondary battery separator of the present disclosure and inorganic fine particles. The slurry composition for a non-aqueous secondary battery separator of the present disclosure has excellent solution stability due to good affinity between the binder dispersion and the inorganic fine particle and exhibits heat resistance and adhesion. Since the increase in viscosity is suppressed even when the molecular weight of the binder is increased due to the good heat resistance and adhesion of the separator, the slurry composition also has excellent coatability.

The slurry composition preferably contains a polymer (A2), if necessary, and the polymer (A2) is preferred because it functions as an adhesive component and improves adhesion to the separator substrate.

### <Inorganic Fine Particle>

The inorganic fine particle is preferably composed of an inorganic compound that does not deteriorate in the electrolytic solution of the non-aqueous secondary battery. Specific examples of the inorganic compound include aluminum oxide, hydrated aluminum oxide, silicon oxide, magnesium oxide, calcium oxide, zirconium oxide, titanium oxide, silica, and ion-conductive glass. The inorganic compound may be used alone or in combination with two or more.

The average particle size of the inorganic fine particle is preferably 0.01 to 10 μm and more preferably 0.1 to 5 μm. The protective layer can achieve both coating strength and lithium ion conductivity at a higher level by using the inorganic fine particle having the above average particle size.

The average particle size of the inorganic fine particle indicates a particle size when an integrated value from the small particle size side reaches 50% in the particle size distribution on a volume basis (volume distribution) by a laser diffraction/scattering method or a dynamic light scattering method.

The polymer (A1) is used in an amount of preferably 0.1 to 10 parts by mass and more preferably 0.2 to 5 parts by mass per 100 parts by mass of the inorganic fine particle. Within the above range, the lithium ion conductivity of the protective layer can be further improved, thereby suppressing internal resistance, while the adhesion between the inorganic fine particles and the excellent adhesion of the protective layer to the separator are maintained.

### <Polymer (A2)>

The slurry composition for a non-aqueous secondary battery separator of the present disclosure preferably further contains a polymer (A2), and the polymer (A2) is a particulate polymer having a glass transition temperature (Tg) of −40 to 40° C.

Note that the polymer (A2) is excluded if it corresponds to the polymer (A1).

The polymer (A2) functions as an adhesive component to the substrate when formed into a slurry composition.

The polymer (A2) that can be used includes, but is not limited to any polymer as long as it has a glass transition temperature of −40 to 40° C. and is in the form of particles, any components such as an acrylic resin, a styrene acrylic resin, a butadiene resin, an olefin resin, a urethane resin, a polyester resin, and a natural polymer such as a polysaccharide. However, an acrylic resin or a styrene acrylic resin is preferably used from the viewpoint of mixing stability with the polymer (A1) and good adhesion to a non-conductive fine particle and an olefin substrate.

In the case of using the polymer (A2), the content of the polymer (A2) in the slurry composition is preferably 200 parts by mass or less and more preferably 10 to 100 parts by mass per 100 parts by mass of the polymer (A1). By containing the polymer (A2) in the above range, the slurry composition has improved adhesion to the separator substrate and better cycle characteristics.

When the polymer (A2) is a polymer of an ethylenically unsaturated monomer, the same method as described in the polymer (A1) can be used as the method for manufacturing the polymer (A2).

The polymer (A2) is a particulate polymer dispersed in an aqueous medium, which readily exhibits adhesion to the substrate. The polymer (A2) has an average particle size of preferably 50 to 500 nm and more preferably 60 to 400 nm under the condition of a solid concentration of 1% by mass. Within the above range, gaps between the inorganic fine particles are not filled when the polymer (A2) is formed into a slurry composition, resulting in good ion permeability of the separator.

The average particle size can be determined by, for example, dynamic light scattering measurement (measurement device: Nanotrac UPA, manufactured by MicrotracBEL Corp., etc.). The peak of the volume particle size distribution data (histogram) obtained at this time is used as the average particle size.

The slurry composition for a non-aqueous secondary battery of the present disclosure is preferably blended with, as other optional components, polymers other than the polymer (A1) and the polymer (A2), a leveling agent, a dispersant, a thickener, an antifoaming agent, and the like. Examples of the type of the leveling agent include a silicon-based agent, a fluorine-based agent, a metal-based agent, and a succinic acid-based agent. Examples of the dispersant include an anionic compound, a nonionic compound, and a polymer compound.

### <Method for Manufacturing Slurry Composition>

The slurry composition for a non-aqueous secondary battery of the present disclosure is formed by mixing the binder dispersion for a non-aqueous secondary battery separator of the present disclosure, inorganic fine particles, and an optional additive such as the polymer (A2). The slurry composition can be formed by, for example, dispersing the inorganic fine particles with a dispersant and then mixing the binder dispersion with an optional additive.

The slurry composition for a non-aqueous secondary battery of the present disclosure can be manufactured using a known disperser or mixer. Specific examples of the mixing device include mixers such as a disper mixer, a homomixer, and a planetary mixer; homogenizers; media-type dispersers such as a paint conditioner, a ball mill, a sand mill, an attritor, a pearl mill, and a co-ball mill; medialess dispersers such as a jet mill; and other roll mills. In addition, the disperser to be used is preferably a disperser that has been treated to prevent metal contamination from the disperser. The media to be used is preferably a ceramic bead such as a glass bead, a zirconia bead, and an alumina bead. Only one dispersing device may be used, or a plurality of the devices may be used in combination.

### <<Non-aqueous Secondary Battery Separator>>

The non-aqueous secondary battery separator of the present disclosure include a protective layer formed from the slurry composition on at least one surface of a separator substrate. This protective layer improves the heat resistance of the separator and reduces the risk of explosion of the non-aqueous secondary battery due to a short circuit between electrodes when the non-aqueous secondary battery overheats.

The separator substrate is a sheet of porous layer or a nonwoven fabric with fine pores through which ions can penetrate. Specifically, the separator substrate can be composed of a known material such as polyolefin including polyethylene or polypropylene, cellulose, and aromatic polyamide.

The method of forming the protective layer is preferably a method of applying a slurry composition. Specific examples of such a coating method include a die coating method, a dip coating method, a roll coating method, a doctor coating method, a knife coating method, a spray coating method, a gravure coating method, a screen printing method, and an electrostatic painting method. In addition, it is preferable to dry the solvent during coating. Specifically, known drying methods such as standing drying, blast drying, hot air drying, infrared drying, and far infrared drying can be used. The coating may be followed by a rolling treatment using a lithographic press, a calender roll, or the like.

The thickness of the protective layer is preferably 0.5 to 10 μm and more preferably 1 to 5 μm. Within the above range, the protective layer can ensure sufficient strength as a coating film and exhibit excellent battery performance.

### <<Non-aqueous Secondary Battery>>

The non-aqueous secondary battery of the present disclosure will be described using a LIB as an example. The LIB includes at least a battery main body with a positive electrode, a negative electrode, and a separator provided between the positive electrode and the negative electrode; and an electrolytic solution impregnated in the battery main body.

The positive and negative electrodes (hereinafter sometimes referred to as “electrodes”) have a current collector and a composite layer formed from a composite ink containing an electrode active material as an essential component.

A composite ink for a general electrical storage device contains an active material and a solvent as essential components, and if necessary, a conductive auxiliary agent and a binder. The active material is preferably contained as much as possible. For example, a ratio of the active material in the solid content of the composite ink is preferably 80 to 99% by mass. When the conductive auxiliary agent is contained, the ratio of the conductive auxiliary agent in the solid content of the composite ink is 0.1 to 15% by mass. When the binder is contained, the ratio of the binder in the solid content of the composite ink is preferably 0.1 to 15% by mass.

The current collector that can be selected as appropriate is a current collector applicable to various secondary batteries. Examples of the material of the current collector include metals such as aluminum, copper, nickel, titanium, and stainless steel, and alloys thereof. In the case of the LIB, it is preferable to use a current collector composed of aluminum for the positive electrode and a current collector composed of copper for the negative electrode. Regarding the shape, a flat foil is generally used, but a current collector having a roughened surface, a perforated foil, and a mesh shape can also be used. The current collector preferably has a thickness of 5 to 50 μm.

The positive electrode active material that can be used include, but is not particularly limited to, a metal oxide capable of doping or intercalating lithium ions, a metal compound such as metal sulfide, and a conductive polymer. Examples of the metal oxide or metal compound include oxides of transition metals such as Fe, Co, Ni, and Mn, composite oxides with lithium, and inorganic compounds such as transition metal sulfide. Specific examples of the metal oxide or metal compound include transition metal oxide powders such as MnO, V₂O₅, V₆O₁₃, and TiO₂; composite oxide powders of lithium and transition metals such as lithium nickelate, lithium cobaltate, lithium manganate with a layered structure, and lithium manganate with a spinel structure; lithium iron phosphate materials which are lithium acid compounds with an olivine structure; and transition metal sulfide powders such as TiS₂ and FeS.

The negative electrode active material is not particularly limited as long as it can be doped or intercalated with lithium ions. Examples of the negative electrode active material include metal Li and alloys thereof such as a tin alloy, a silicon alloy, and a lead alloy: metal oxides such as lithium titanate, lithium vanadate, and lithium silicate; conductive polymers such as polyacetylene and poly-p-phenylene; amorphous carbonaceous materials such as soft carbon and hard carbon; artificial graphite such as a highly graphitized carbon material; carbonaceous powders such as natural graphite; and carbonaceous materials such as carbon black, mesophase carbon black, a resin-fired carbon material, a vapor grown carbon fiber, and a carbon fiber.

The conductive auxiliary agent in the composite ink is not particularly limited as long as it is a carbon material having conductivity. Examples of the carbon material having conductivity include graphite, carbon black, conductive carbon fibers (carbon nanotube, carbon nanofiber, and carbon fiber), and fullerene.

The binder in the composite ink is used to bind particles of, for example, the active material and the conductive carbon material to each other or bind the conductive carbon material to the current collector.

Examples of the binder used in the composite ink include cellulose resins such as acrylic resin, polyurethane resin, polyester resin, phenol resin, epoxy resin, phenoxy resin, urea resin, melamine resin, alkyd resin, formaldehyde resin, silicon resin, fluorine resin, and carboxymethyl cellulose; synthetic rubbers such as styrene-butadiene rubber and fluorine rubber; conductive resins such as polyaniline and polyacetylene; and polymer compounds containing a fluorine atom such as polyvinylidene fluoride, polyvinyl fluoride, and tetrafluoroethylene. The binder may also be a modified product, mixture, or polymer of these resins.

Furthermore, the composite ink may be blended with a film forming aid, an antifoaming agent, a leveling agent, an antiseptic, a pH adjuster, a viscosity adjuster, and the like, if necessary.

The electrolytic solution is a liquid in which an electrolyte containing lithium is dissolved in a nonaqueous solvent. Specific examples of the electrolyte include LiBF₄, LiClO₄, LiPF₆, LiAsF₆, LiSbF₆, LiCF₃SO₃, Li(CF₃SO₂)₂N, LiC₄F₉SO₃, Li(CF₃SO₂)₃C, LiI, LiBr, LiCl, LiAICl, LiHF₂, LISCN, and LiBPh₄.

Examples of the nonaqueous solvent include carbonates such as ethylene carbonate, propylene carbonate, butylene carbonate, dimethyl carbonate, ethyl methyl carbonate, and diethyl carbonate; lactones such as γ-butyrolactone, γ-valerolactone, and γ-octanoic lactone; glymes such as tetrahydrofuran, 2-methyltetrahydrofuran, 1,3-dioxolane, 4-methyl-1,3-dioxolane, 1,2-methoxyethane, 1,2-ethoxyethane, and 1,2-dibutoxyethane; esters such as methyl formate, methyl acetate, and methyl propionate; sulfoxides such as dimethyl sulfoxide and sulfolane; and nitriles such as acetonitrile.

In addition, the electrolytic solution is preferably used as a polymer electrolyte which is formed into a gel by being held in a polymer matrix. Examples of the polymer matrix include an acrylic resin having a polyalkylene oxide segment, a polyphosphazene resin having a polyalkylene oxide segment, and a polysiloxane resin having a polyalkylene oxide segment.

The non-aqueous secondary battery using the above-described member is excellent in safety and cell characteristics. The non-aqueous secondary battery of the present disclosure can be used for industrial, in-vehicle, and mobile applications.

### EXAMPLES

Hereinafter, the present disclosure will be described in more detail with reference to Examples, but the Examples below are not intended to limit the scope of the present disclosure. Note that “parts” and “%” in the Examples represent “parts by mass” and “% by mass”, respectively; numerical values in tables represents solid mass; and a blank represents no use.

Methods of measuring the average particle size of the inorganic fine particle and the glass transition temperature (Tg) of the polymer are each described below.

### <Average Particle Size of Inorganic Fine Particle>

The average particle size of the inorganic fine particle was determined from a particle size when an integrated value from the small particle size side reaches 50% in the particle size distribution on a volume basis (volume distribution) by a laser diffraction/scattering method.

### <Glass Transition Temperature>

The glass transition temperature of the polymer was measured using a differential scanning calorimeter (DSC, manufactured by TA Instruments). Specifically, an aluminum pan in which about 3 mg of dried resin was precisely weighed and an empty aluminum pan as a reference were set in a DSC measurement holder and measured under a temperature rising condition of 10° C./min, and a temperature at an intersection of a baseline on the low temperature side of an endothermic phenomenon in the resulting DSC curve and a tangent line at an inflection point was defined as a glass transition temperature (Tg).

Hereinafter, examples relating to the first embodiment and the second embodiment will be described in order. Note that the examples are independent of each embodiment, and even when the same reference numerals are used, the embodiments may not be related to each other.

### 1. Examples of First Embodiment

### <Preparation Polymer (A2-1a) Dispersion>

A reaction vessel equipped with a stirring device, a thermometer, a dropping funnel, and a reflux device was charged with 40 parts of ion-exchanged water and 0.2 parts of Aqualon KH-10 (manufactured by DKS Co. Ltd.) as a surfactant. Separately, 1% of a pre-emulsion prepared in advance by mixing 61 parts of 2-ethylhexyl acrylate, 30 parts of methyl methacrylate, 7 parts of styrene, 0.5 parts of methacrylamide, 1.5 parts of acrylic acid, 53 parts of ion-exchanged water, and 1.8 parts of Aqualon KH-10 (manufactured by DKS Co. Ltd.) as a surfactant was further added thereto. Subsequently, the reaction vessel was heated to an internal temperature of 60° C. and sufficiently replaced with nitrogen. Then, 10 parts of a 5% aqueous solution of potassium persulfate and 10% of 20 parts of a 1% aqueous solution of anhydrous sodium hydrogen sulfite were added to initiate polymerization. After the reaction system was maintained at 60° C. for five minutes, the remainder of the pre-emulsion, the 5% aqueous solution of potassium persulfate, and the remainder of the 1% aqueous solution of anhydrous sodium hydrogen sulfite were added dropwise over 1.5 hours while the internal temperature was maintained at 60° C. The mixture was further stirred for two hours. Once a conversion rate of over 98% was confirmed through solid content measurement, the temperature was cooled to 30° C. 25% aqueous ammonia was added to adjust a pH to 8.5, and the solid content was further adjusted to 40% with ion-exchanged water to obtain a polymer (A2-1a) dispersion having a Tg of −12° C. The solid content was determined by residue on baking at 150° C. for 20 minutes.

### Example a1

### <Manufacture of Binder Dispersion for Non-aqueous Secondary Battery Separator>

48 parts of acrylamide, 47 parts of 2-hydroxyethyl acrylate, 3 parts of diacetone acrylamide, 2 parts of butyl acrylate, and 90 parts of ion-exchanged water were mixed to form a mixed solution. A reaction vessel equipped with a stirrer, a thermometer, a dropping funnel, and a reflux device was charged with 450 parts of water and 30 parts of the mixed solution. Subsequently, the reaction vessel was heated to have an internal temperature of 80° C. and sufficiently replaced with nitrogen, and 25 parts (solid content: 2.5 parts) of a 10% aqueous solution of ammonium persulfate was added thereto as an initiator to initiate a reaction. The mixture was added dropwise over 60 minutes while the internal temperature was maintained at 80° C. After completion of the dropping, the mixture was further reacted at 80° C. for three hours. Once a conversion rate of over 98% was confirmed through solid content measurement, the temperature was cooled to 30° C. The solid content was adjusted to 15% with ion-exchanged water to obtain a binder dispersion for a non-aqueous secondary battery separator containing the polymer (A1-1a). The solid content was determined by residue on baking at 150° C. for 20 minutes.

### Examples 2a to 18a and Comparative Example 1a to 6a

Binder dispersions for a non-aqueous secondary battery separator containing polymers (A1-2a to 18a) or polymers (A3a-1 to 6a) were each obtained in the same manner as in Example 1a except that the blending composition and blend quantity (parts by mass) were as shown in Table 1A. Note that in Examples 6a, 8a, and 10a and Comparative Example 5a, 25% aqueous ammonia was added after completion of the reaction in an equivalent molar amount to a carboxyl group in the resin for neutralization.

In addition, Comparative Examples 2a and 3a could not be synthesized due to poor polymerization stability.

Physical property values and evaluation results of the resulting polymers and binder dispersions for a non-aqueous secondary battery separator were determined by a method below. The results are shown in Table 1A to 3A.

### <Acid Value>

The acid value of the polymer is the number of milligrams of potassium hydroxide required to neutralize acidic components contained in 1 g of dried resin. According to the method described in JIS K2501, potentiometric titration was performed using an automatic titrator (“COM-A19”, manufactured by HIRANUMA Co., Ltd.) with a potassium hydroxide-ethanol solution to calculate the acid value.

### <Light Transmittance>

The resulting binder dispersion was adjusted to have a solid concentration of 5% with ion-exchanged water and placed in a quartz cell with an optical path length of 1 cm, and then a transmission spectrum thereof was measured at a wavelength of 400 nm using a spectrophotometer (“V-770”, manufactured by JASCO Corporation). The ion-exchanged water was used for comparison.
A: Light transmittance of less than 50%.
B: Light transmittance of 50% or more and less than 70%.
C: Light transmittance of 70% or more.

### <Storage Modulus>

The resulting binder dispersion was dried at 40° C. for 72 hours to make a film having a thickness of about 0.5 mm. The resulting film was cut into a strip having a size of 5 mm width×20 mm length as a sample, and the storage modulus 150° C. was measured using a dynamic viscoelasticity measuring device (“DVA-200”, manufactured by IT Keisoku Seigyo Co., Ltd.). The measurement conditions were as follows:
Measurement mode: Tensile
Frequency: 10 Hz
Strain: 0.01%
Temperature rising condition: 10° C./min
A: Storage modulus of 1.0×10⁷ Pa or more.
B: Storage modulus of 1.0×10⁶ or more and less than 1.0×10⁷ Pa.
C: Storage modulus of less than 1.0×10⁶ Pa.

### <Viscosity>

The viscosity of the resulting binder dispersion with a solid concentration of 15% was measured (temperature: 25° C., spindle rotation time: 60 seconds, spindle rotation speed: 20 rpm) using a B-type viscometer (“TVB10”, manufactured by Toki Sangyo Co., Ltd.).
A: Viscosity of 3,000 mPa·s or more and less than 20,000 mPa·s.
B: Viscosity of 2,500 mPa·s or more and less than 3,000 mPa·s.
B′: Viscosity of 20,000 mPa·s or more and less than 25,000 mPa·s.
C: Viscosity of less than 2,500 mPa·s.
C′: Viscosity of 25,000 mPa·s or more.

### <Average Particle Size>

The average particle size can be determined by diluting a solution of the polymer with water to a solid concentration of 1% by mass and measuring about 5 ml of the diluted solution by dynamic light scattering measurement (measurement device: Nanotrac UPA, manufactured by MicrotracBEL Corp). The peak of the volume particle size distribution data (histogram) obtained at this time was used as the average particle size.
A: Particle size of 100 nm or more and less than 3,000 nm.
B: Particle size of 3,000 nm or more and less than 4,000 nm or 10 nm or more and less than 100 nm.
C: Particle size of less than 10 nm or 4,000 nm or more.

### <<Evaluation of Binder Dispersion>>

### <Electrolytic Solution Resistance>

Electrolytic solution resistance, the ease of dissolution and swelling of the polymer in an electrolytic solution, was evaluated by the electrolytic solution swelling degree. The smaller the electrolytic solution swelling degree, the better the electrolytic solution resistance.

The resulting binder dispersion was dried at 40° C. for 72 hours to make a film having a thickness of about 1 mm. Subsequently, the film was cut into a size of 10 mm length×10 mm width as a sample, and the sample was immersed in a mixed solvent of ethylene carbonate and diethyl carbonate in a volume ratio of 2:3 at 60° C. for 72 hours. The swelling degree of the film before and after immersion was calculated as follows:

Swelling degree(times)=(mass after immersion)/(mass before immersion)
A: Swelling degree of less than 1.5 times.
B: Swelling degree of 1.5 times or more and less than 2 times.
C: Swelling degree of 2 times or more.

TABLE 1A

| | | | Example | Example | Example | Example | Example | Example | Example | Example |
|---|---|---|---|---|---|---|---|---|---|---|
| | | | 1a | 2a | 3a | 4a | 5a | 6a | 7a | 8a |
| Polymer | Name | | Polymer | Polymer | Polymer | Polymer | Polymer | Polymer | Polymer | Polymer |
| | | | A1 - 1a | A1 - 2a | A1 - 3a | A1 - 4a | A1 - 5a | A1 - 6a | A1 - 7a | A1 - 8a |
| | Acrylamide | | 48 | 68 | 60 | 43 | 72 | 57 | 55 | 41 |
| | Methacrylamide | | | 3 | | 2 | | | 15 | |
| | Nonionic | MA | | | 10 | | | 3.8 | 3 | 20 |
| | monomer | MMA | | 23 | | 3 | 17 | | 9 | 20 |
| | (a-1a) | EA | | 4 | 10 | | 6 | | | |
| | | 2HEMA | 47 | | 20 | 52 | | 38 | 16 | 14 |
| | | DAAM | 3 | | | | | | | 4 |
| | Other | AA | | | | | | 1.2 | | 1 |
| | monomer | 2HEA | | 2 | | | | | | |
| | (a-2) | St | | | | | 5 | | | |
| | | BA | 2 | | | | | | 2 | |
| | | EGDMA | | | | | | | | |

| | Acid value (mgKOH/g) | 0.0 | 0.0 | 0.0 | 0.0 | 0.0 | 9.3 | 0.0 | 7.8 |
|---|---|---|---|---|---|---|---|---|---|
| 10% aqueous solution | | 2.5 | 2.5 | 2.5 | 2.5 | 2.5 | 2.5 | 2.5 | 2.5 |
| of ammonium persulfate | | | | | | | | | |
| Physical | Light transmittance | A | A | A | A | A | A | A | A |
| property | Storage modulus | A | A | A | A | A | A | A | B |
| value | Viscosity | A | A | A | A | A | A | A | B |
| | Average particle size | A | A | A | A | A | A | A | A |
| Evaluation | Electrolytic | A | A | A | A | A | A | A | B |
| | solution resistance | | | | | | | | |

TABLE 2A

| | | | Example | Example | Example | Example | Example | Example | Example | Example |
|---|---|---|---|---|---|---|---|---|---|---|
| | | | 9a | 10a | 11a | 12a | 13a | 14a | 15a | 16a |
| Polymer | Name | | Polymer | Polymer | Polymer | Polymer | Polymer | Polymer | Polymer | Polymer |
| | | | A1 - 9a | A1 - 10a | A1 - 11a | A1 - 12a | A1 - 13a | A1 - 14a | A1 - 15a | A1 - 16a |
| | Acrylamide | | 78 | 50 | 60 | 45 | 45 | 40 | 48 | 48 |
| | Methacrylamide | | | 1.1 | 9 | | | | | |
| | Nonionic | MA | 5 | 7 | | 2 | 2 | | | |
| | monomer | MMA | 10 | 7 | 4 | | | | | |
| | (a-1a) | EA | 5 | | | 25 | 25 | 36 | | |
| | | 2HEMA | | 33 | 17 | 23 | 23 | 20 | 47 | 47 |
| | | DAAM | | | 5 | | | | 3 | 3 |
| | Other | AA | | 1.9 | | | | | | |
| | monomer | 2HEA | 2 | | 5 | | | | | |
| | (a-2) | St | | | | | | | 2 | 2 |
| | | BA | | | | 5 | 5 | 4 | | |
| | | EGDMA | | | | | | | | |

| | Acid value (mgKOH/g) | 0.0 | 14.8 | 0.0 | 0.0 | 0.0 | 0.0 | 0.0 | 0.0 |
|---|---|---|---|---|---|---|---|---|---|
| 10% aqueous solution | | 2.5 | 2.5 | 2.5 | 2.5 | 3.5 | 2.5 | 1.5 | 3.5 |
| of ammonium persulfate | | | | | | | | | |
| Physical | Light transmittance | A | A | B | A | B | B | A | A |
| property | Storage modulus | A | A | A | B | C | C | A | B |
| value | Viscosity | B′ | A | B′ | A | B | A | B′ | B |
| | Average particle size | A | A | B | A | B | B | A | A |
| Evaluation | Electrolytic | A | A | A | B | B | C | A | B |
| | solution resistance | | | | | | | | |

TABLE 3A

| | | | | | Compar- | Compar- | Compar- | Compar- | Compar- | Compar- |
|---|---|---|---|---|---|---|---|---|---|---|
| | | | | | ative | ative | ative | ative | ative | ative |
| | | | Example | Example | Exam- | Exam- | Exam- | Exam- | Exam- | Exam- |
| | | | 17a | 18a | ple 1a | ple 2a | ple 3a | ple 4a | ple 5a | ple 6a |
| Polymer | Name | | Polymer | Polymer | Polymer | Polymer | Polymer | Polymer | Polymer | Polymer |
| | | | A1 - 17a | A1 - 18a | A3 - 1a | A3 - 2a | A3 - 3a | A3 - 4a | A3 - 5a | A3 - 6a |
| | Acrylamide | | 68 | 68 | 57 | 63 | 31 | 77 | 56 | 73 |
| | Methacrylamide | | 3 | 3 | | | | 5 | | |
| | Nonionic | MA | | | | | 20 | | | |
| | monomer | MMA | 23 | 23 | | | 28 | 5 | | |
| | (a-1a) | EA | 4 | 4 | | | | | 24 | |
| | | 2HEMA | | | | | 20 | 3 | | 11 |
| | | DAAM | | | | | | 10 | 16 | 11 |
| | Other | AA | | | | | | | 4 | |
| | monomer | 2HEA | 2 | 2 | 43 | | | | | 5 |
| | (a-2) | St | | | | | | | | |
| | | BA | | | | 37 | 1 | | | |
| | | EGDMA | | | | | | | | |

| | Acid value (mgKOH/g) | 0.0 | 0.0 | 0.0 | 0.0 | 0.0 | 0.0 | 31.1 | 0.0 |
|---|---|---|---|---|---|---|---|---|---|
| 10% aqueous solution | | 1 | 4 | 2.5 | 2.5 | 2.5 | 2.5 | 2.5 | 2.5 |
| of ammonium persulfate | | | | | | | | | |
| Physical | Light transmittance | A | A | C | — | — | C | A | C |
| property | Storage modulus | A | B | B | — | — | A | A | A |
| value | Viscosity | C′ | C | C′ | — | — | C′ | A | C′ |
| | Average particle size | A | A | C | — | — | C | A | C |
| Evaluation | Electrolytic | A | B | A | — | — | A | A | A |
| | solution resistance | | | | | | | | |

Abbreviations in the tables are listed below.

<Nonionic Ethylenically Unsaturated Monomer (a-1a)>
MA: Methyl acrylate (log Kow: 0.59)
MMA: Methyl methacrylate (log Kow: 1.13)
EA: Ethyl acrylate (log Kow: 1.08)
2HEMA: 2-Hydroxyethyl methacrylate (log Kow: 0.33)
DAAM: Diacetone acrylamide (log Kow: 0.82)
   <Another ethylenically unsaturated monomer (a-2)>
AA: Acrylic acid (log Kow: 0.67, ionic ethylenically unsaturated monomer)
2HEA: Hydroxyethyl acrylate (log Kow:−0.22)
St: Styrene (log Kow: 2.71)
BA: Butyl acrylate (log Kow: 2.23)
EGDMA: Ethylene glycol dimethacrylate (log Kow: 2.07)

### Example 19a

### <Preparation of Slurry Composition for Non-aqueous Secondary Battery Separator>

In a bead mill, 42.4 parts of inorganic fine particles (alumina, average particle size: 0.5 μm), 0.5 parts of ammonium polycarboxylate (BYK-154) as a dispersant, and 42.7 parts of water were fed to make a dispersion of alumina. To the resulting alumina dispersion were added 1.1 parts of a binder dispersion containing the polymer (A-1a) in terms of solid content, 0.6 parts of a 4% aqueous solution of carboxymethyl cellulose (CMC, Daicel 1220) as a thickener, 0.3 parts of a silicon-based activating agent (BYK-349) as a wetting agent, and 0.2 parts of a silicon-based antifoaming agent (BYK-018), and water was added to the mixture so as to have a solid concentration of 43%. Then, they were mixed to make a slurry composition for a non-aqueous secondary battery separator.

### <Production of Non-aqueous Secondary Battery Separator>

The slurry composition was applied onto one surface of a separator substrate (9 μm porous polyethylene film) with a doctor blade to a thickness of 3 μm, then dried in an oven at 80° C. to obtain a separator with a protective layer.

### (Production of Positive Electrode)

A composite ink for a positive electrode was produced by adding and mixing 93 parts of LiNi_{0.5}Mn_{0.3}Co_{0.2}O₂ as a positive electrode active material, 4 parts of acetylene black as a conductive agent, 3 parts of polyvinylidene fluoride as a binder, and 45 parts of N-methylpyrrolidone. The resulting composite ink for a positive electrode was applied onto a 20 μm-thick aluminum foil serving as a current collector with a doctor blade, then dried by heating at 80° C. to adjust the weight per unit area of the electrode to 20 mg/cm². The resultant was subjected to a rolling treatment with a roll press, thereby producing a positive electrode with a composite layer having a density of 3.1 g/cm³.

### (Production of Negative Electrode)

A composite ink for a negative electrode was produced by kneading 98 parts of artificial graphite as a negative electrode active material and 66.7 parts of a 1.5% aqueous solution of carboxymethyl cellulose (1 part as a solid content) in a planetary mixer and mixing 33 parts of water and 2.08 parts of a 48% aqueous dispersion of a styrene-butadiene emulsion (1 part as a solid content). The resulting composite ink for a negative electrode was applied onto a 20 μm-thick copper foil serving as a current collector with a doctor blade, then dried by heating at 80° C. to adjust the weight per unit area of the electrode to 12 mg/cm². The resultant was subjected to a rolling treatment with a roll press, thereby producing a negative electrode with a composite layer having a density of 1.5 g/cm³.

### <Preparation of Non-aqueous Secondary Battery>

The positive and negative electrodes were punched to a size of 45 mm×40 mm and 50 mm×45 mm, respectively. The positive electrode and the negative electrode were inserted into an aluminum laminate bag opposite to each other via a separator with a protective layer and dried in a vacuum. Then, an electrolytic solution (non-aqueous electrolytic solution in which LiPF6 was dissolved at a concentration of 1M in a mixed solvent of ethylene carbonate and diethyl carbonate mixed in a volume ratio of 2:3) was injected, and the aluminum laminate was sealed to produce a laminated non-aqueous secondary battery.

### Examples 20a to 36a, 41a, and 42a and Comparative Example 7a to 11a

A slurry composition for a non-aqueous secondary battery separator, a non-aqueous secondary battery separator, and a non-aqueous secondary battery were produced in the same manner as in Example 19a, except that the composition and blend quantity (parts by mass) were changed as shown in Table 4A.

### Example 37a

In a bead mill, 42.4 parts of inorganic fine particles (alumina, average particle size: 0.5 μm), 0.5 parts of ammonium polycarboxylate (BYK-154) as a dispersant, and 42.7 parts of water were fed to make a dispersion of alumina. To the resulting alumina dispersion were added 1.0 part of a binder dispersion containing the polymer (A1-8a) in terms of solid content, 0.1 parts of a dispersion containing the polymer (A2-1a) in terms of solid content, 0.6 parts of a 4% aqueous solution of carboxymethyl cellulose (CMC, Daicel 1220) as a thickener, 0.3 parts of a silicon-based activating agent (BYK-349) as a wetting agent, and 0.2 parts of a silicon-based antifoaming agent (BYK-018), and water was added to the mixture so as to have a solid concentration of 43%. Then, they were mixed to make a slurry composition for a non-aqueous secondary battery separator.

### Examples 38a to 40a

A slurry composition for a non-aqueous secondary battery separator, a non-aqueous secondary battery separator, and a non-aqueous secondary battery were produced in the same manner as in Example 37a, except that the composition and blend quantity (parts by mass) were changed as shown in Table 4A.

The resulting slurry composition for a non-aqueous secondary battery separator, the non-aqueous secondary battery separator, and the non-aqueous secondary battery were used to evaluate solution stability and coatability, adhesion of the protective layer to the separator substrate and heat resistance, and initial resistance and cycle characteristics, respectively, by methods described below. The results are shown in Table 4A.

### <<Evaluation of Slurry Composition>>

### <Solution Stability>

The slurry composition was stored at 50° C. and visually inspected for aggregation, precipitation, and separation.

### [Evaluation Criteria]

oo: No abnormality observed for two weeks or more from the start of storage. Extremely good.
o: Some abnormality observed after one week or more and less than two weeks from the start of storage. Good.
Δ: Some abnormality observed after four days or more and less than one week from the start of storage. Available.
x: Some abnormality observed within three days from the start of storage. Problem in practical use.

### <Coatability>

The slurry composition was visually observed to evaluate the coatability using the resulting separator.

### [Evaluation Criteria]

oo: Even film thickness and no cissing. Extremely good.
o: Unevenness or cissing in less than 5% of the coated portion. Good.
Δ: Unevenness or cissing in 5% or more and less than 10% of the coated portion. Available.
x: Unevenness or cissing in 10% or more of the coated portion. Problem in practical use.

### <<Evaluation of Separator>>

### <Heat Resistance of Separator>

The separator was cut into a size of 100 mm in MD (flow direction)×100 mm in TD (vertical direction) to prepare a sample. The sample was sandwiched between three sheets of paper and placed in an oven at 150° C. for two hours. After the sample was removed from the oven and allowed to cool, the shrinkage rate was calculated as follows:

$$Sample area ( {mm}^{2} ) = ( MD length of sample ) \times ( TD length of sample )$$

$$Shrinkage ratio ( \% ) = [ \text{} ( sample area after heating ) / ( sample area before heating ) ] \times 100$$

### [Evaluation Criteria]

oo: Shrinkage ratio of less than 7%. Extremely good.
o: Shrinkage ratio of 7% or more and less than 15%. Good.
Δ: Shrinkage ratio of 15% or more and less than 30%. Practically available.
x: Shrinkage ratio of 30% or more. Problem in practical use.

### <Adhesion of Protective Layer to Separator Substrate>

The resulting separator with a protective layer was cut into a size of 25 mm width×100 mm length, and the substrate side of the separator was attached to a stainless steel plate with a double-sided tape. A scotch tape with a width of 18 mm was attached onto the protective layer side and roll-crimped at a load of 1 kg. After being allowed to stand for 24 hours under conditions of a temperature of 50° C. and a humidity of 50%, one end of the scotch tape was pulled in a direction of 180° to measure peel strength with a tensile tester (“AGS-X”, manufactured by Shimadzu Corporation) (peel rate: 10 mm/min, unit: N/18 mm width).

### [Evaluation Criteria]

oo: Peel strength of 3 N/18 mm or more. Extremely good.
o: Peel strength of 2 N/18 mm or more and less than 3 N/18 mm. Good.
Δ: Peel strength of 1.5 N/18 mm and less than 2 N/18 mm. Practically available.
x: Peel strength of less than 1.5 N/18 mm. Problem in practical use.

### <<Evaluation of Non-aqueous Secondary Battery>>

### <Internal Resistance>

Internal resistance was the time taken for 100 ml of air to pass through the sample and was evaluated by air permeability. The shorter the time taken, the smaller the internal resistance tends to be and the better the internal resistance. According to the method described in JIS P8117, the air permeability was measured using a Gurley type air permeability tester (“G-B3C”, manufactured by Toyo Seiki Seisaku-sho, Ltd.).

### [Evaluation Criteria]

oo: Less than 260 sec/100 ml. Extremely good.
o: 260 sec/100 ml or more and less than 270 sec/100 ml. Good.
Δ: 270 sec/100 ml or more and less than 280 sec/100 ml. Practically available.
x: 280 sec/100 ml or more. Problem in practical use.

### <Cycle Characteristics>

In a thermostatic chamber at 50° C., constant current, constant voltage charge (cut-off current: 0.6 mA) was performed at a charging current of 60 mA and an end-of-charge voltage of 4.2 V, followed by constant current discharge at a discharging current of 60 mA until the end-of-charge voltage reached 3.0 V to determine an initial discharge capacity. This charge-discharge cycle was performed 200 times to calculate a discharge capacity retention rate (percentage of the tenth discharge capacity with respect to the initial discharge capacity).

The higher the discharge capacity retention ratio, the better the cycle characteristics.

### [Evaluation Criteria]

oo: Discharge capacity retention ratio of 90% or more. Extremely good.
o: Discharge capacity retention ratio of 85% or more and less than 90%. Good.
Δ: Discharge capacity retention ratio of 80% or more and less than 85%. Practically available.
x: Discharge capacity retention ratio of less than 80%. Problem in practical use.

TABLE 4A

| | Inorganic | | | | | | | | | Non-aqueous | |
|---|---|---|---|---|---|---|---|---|---|---|---|
| | filler | Polymer (1) | | Polymer (2) | | | | | | secondary battery | |
| | Blend | | Blend | | Blend | Slurry composition | | Separator | | | Cycle |
| | quantity | | quantity | | quantity | Solution | | Heat | | Internal | charac- |
| | (parts) | Type | (parts) | Type | (parts) | stability | Coatability | resistance | Adhesion | resistance | teristics |
| Example 19a | 42.4 | Polymer | 1.1 | — | — | ∘∘ | ∘∘ | ∘∘ | ∘∘ | ∘∘ | ∘∘ |
| | | (A1 - 1a) | | | | | | | | | |
| Example 20a | 42.4 | Polymer | 1.1 | — | — | ∘∘ | ∘∘ | ∘∘ | ∘∘ | ∘∘ | ∘∘ |
| | | (A1 - 2a) | | | | | | | | | |
| Example 21a | 42.4 | Polymer | 1.1 | — | — | ∘∘ | ∘∘ | ∘∘ | ∘∘ | ∘∘ | ∘∘ |
| | | (A1 - 3a) | | | | | | | | | |
| Example 22a | 42.4 | Polymer | 1.1 | — | — | ∘∘ | ∘∘ | ∘∘ | ∘∘ | ∘∘ | ∘∘ |
| | | (A1 - 4a) | | | | | | | | | |
| Example 23a | 42.4 | Polymer | 1.1 | — | — | ∘∘ | ∘∘ | ∘∘ | ∘∘ | ∘∘ | ∘∘ |
| | | (A1 - 5a) | | | | | | | | | |
| Example 24a | 42.4 | Polymer | 1.1 | — | — | ∘∘ | ∘∘ | ∘∘ | ∘∘ | ∘∘ | ∘∘ |
| | | (A1 - 6a) | | | | | | | | | |
| Example 25a | 42.4 | Polymer | 1.1 | — | — | ∘∘ | ∘∘ | ∘∘ | ∘∘ | ∘∘ | ∘∘ |
| | | (A1 - 7a) | | | | | | | | | |
| Example 26a | 42.4 | Polymer | 1.1 | — | — | ∘∘ | ∘ | ∘ | ∘ | ∘ | ∘ |
| | | (A1 - 8a) | | | | | | | | | |
| Example 27a | 42.4 | Polymer | 1.1 | — | — | ∘∘ | ∘ | ∘∘ | ∘∘ | ∘∘ | ∘ |
| | | (A1 - 9a) | | | | | | | | | |
| Example 28a | 42.4 | Polymer | 1.1 | — | — | Δ | ∘∘ | ∘∘ | ∘∘ | ∘∘ | ∘ |
| | | (A1 - 10a) | | | | | | | | | |
| Example 29a | 42.4 | Polymer | 1.1 | — | — | ∘ | ∘ | ∘∘ | ∘∘ | ∘∘ | ∘ |
| | | (A1 - 11a) | | | | | | | | | |
| Example 30a | 42.4 | Polymer | 1.1 | — | — | ∘∘ | ∘∘ | ∘ | ∘∘ | ∘ | ∘ |
| | | (A1 - 12a) | | | | | | | | | |
| Example 31a | 42.4 | Polymer | 1.1 | — | — | ∘ | ∘∘ | Δ | ∘ | ∘ | Δ |
| | | (A1 - 13a) | | | | | | | | | |
| Example 32a | 42.4 | Polymer | 1.1 | — | — | ∘ | ∘∘ | Δ | ∘∘ | Δ | Δ |
| | | (A1 - 14a) | | | | | | | | | |
| Example 33a | 42.4 | Polymer | 1.1 | — | — | ∘∘ | ∘ | ∘∘ | ∘∘ | ∘∘ | ∘ |
| | | (A1 - 15a) | | | | | | | | | |
| Example 34a | 42.4 | Polymer | 1.1 | — | — | ∘∘ | ∘ | ∘ | ∘ | ∘ | ∘ |
| | | (A1 - 16a) | | | | | | | | | |
| Example 35a | 42.4 | Polymer | 1.1 | — | — | ∘∘ | Δ | ∘∘ | ∘∘ | ∘∘ | Δ |
| | | (A1 - 17a) | | | | | | | | | |
| Example 36a | 42.4 | Polymer | 1.1 | — | — | ∘∘ | Δ | ∘ | Δ | ∘ | Δ |
| | | (A1 - 18a) | | | | | | | | | |
| Example 37a | 42.4 | Polymer | 1 | Polymer | 0.1 | ∘∘ | ∘ | ∘ | ∘∘ | ∘ | ∘ |
| | | (A1 - 8a) | | (A2 - 1a) | | | | | | | |
| Example 38a | 42.4 | Polymer | 0.4 | Polymer | 0.7 | ∘∘ | ∘ | ∘ | ∘∘ | ∘ | ∘ |
| | | (A1 - 8a) | | (A2 - 1a) | | | | | | | |
| Example 39a | 42.4 | Polymer | 1.05 | Polymer | 0.05 | ∘∘ | ∘ | ∘ | ∘∘ | ∘ | ∘ |
| | | (A1 - 8a) | | (A2 - 1a) | | | | | | | |
| Example 40a | 42.4 | Polymer | 0.35 | Polymer | 0.75 | ∘∘ | ∘ | ∘ | ∘∘ | ∘ | ∘ |
| | | (A1 - 8a) | | (A2 - 1a) | | | | | | | |
| Example 41a | 42.4 | Polymer | 0.8 | — | — | ∘∘ | ∘∘ | ∘∘ | ∘∘ | ∘∘ | ∘∘ |
| | | (A1 - 1a) | | | | | | | | | |
| Example 42a | 42.4 | Polymer | 1.5 | — | — | ∘∘ | ∘∘ | ∘∘ | ∘∘ | ∘∘ | ∘∘ |
| | | (A1 - 1a) | | | | | | | | | |
| Comparative | 42.4 | Polymer | 1.1 | — | — | x | Δ | ∘ | ∘ | x | x |
| Example 7a | | (A3 - 1a) | | | | | | | | | |
| Comparative | 42.4 | Polymer | 1.1 | — | — | x | Δ | ∘ | ∘ | x | x |
| Example 8a | | (A3 - 4a) | | | | | | | | | |
| Comparative | 42.4 | Polymer | 1.1 | — | — | x | x | Δ | Δ | ∘ | Δ |
| Example 9a | | (A3 - 5a) | | | | | | | | | |
| Comparative | 42.4 | Polymer | 1.1 | — | — | Δ | Δ | ∘ | ∘ | x | x |
| Example 10a | | (A3 - 6a) | | | | | | | | | |
| Comparative | 42.4 | Polymer | 1.1 | — | — | x | ∘ | x | ∘ | ∘ | Δ |
| Example 11a | | (A2 - 1a) | | | | | | | | | |

As shown in Table 4A, a binder dispersion for a non-aqueous secondary battery separator, the binder dispersion including a polymer (A1a) and an aqueous medium, in which the polymer (A1a) had an acid value of 15 mgKOH/g or less and was an ethylenically unsaturated monomer mixture containing 40 to 80% by mass of (meth)acrylamide and 20 to 60% by mass of a nonionic ethylenically unsaturated monomer (a-1a) having an octanol/water partition coefficient logarithm (Log Kow) of 0.25 to 1.5 at 25° C. based on a total mass of the ethylenically unsaturated monomer mixture; and light transmittance at a wavelength of 400 nm was less than 70% under the condition of a solid concentration of 5%, was used in Examples 19 to 42, which had good solution stability and coatability when formed into a slurry composition and were excellent in heat resistance and adhesion when formed into a secondary battery separator, and had small internal resistance and excellent cycle characteristics when formed into a secondary battery. On the other hand, Comparative Example 2 using an ethylenically unsaturated monomer having a Log Kow of more than 1.5 and Comparative Example 3 using a nonionic ethylenically unsaturated monomer (a-1a) in an amount of more than 60% by mass were significantly inferior in polymerization stability. The slurry compositions for a non-aqueous secondary battery separator, the non-aqueous secondary battery separator, and the non-aqueous secondary battery using Comparative Examples 1a and 4a to 6a or without the polymer (A1a) were also extremely inferior in any of the physical properties, and the results were far from meeting the level of practical use.

### 2. Examples of Second Embodiment

### Example 1b

### <Manufacture of Binder Dispersion for Non-aqueous Secondary Battery Separator>

Sixty-six parts of acrylamide, 32 parts of t-butyl methacrylate, 2 parts of 1,9-nonanediol diacrylate, 1.0 part of a 20% aqueous solution of EMAL 2FG, and 90 parts of ion-exchanged water were mixed to form a mixed solution. A reaction vessel equipped with a stirrer, a thermometer, a dropping funnel, and a reflux device was charged with 450 parts of water and 30 parts of the mixed solution. Subsequently, the internal temperature of the reaction vessel was raised to 80° C. and sufficiently replaced with nitrogen, and 2.0 parts (solid content: 0.2 parts) of a 10% aqueous solution of ammonium persulfate was added thereto as an initiator to initiate a reaction. The mixture was added dropwise over 60 minutes while the internal temperature was maintained at 80° C. After completion of the dropping, the mixture was further reacted at 80° C. for three hours. Once a conversion rate of over 98% was confirmed through solid content measurement, the temperature was cooled to 30° C. The solid content was adjusted to 15% with ion-exchanged water to obtain a binder dispersion for a non-aqueous secondary battery separator containing the polymer (A1-1b). The solid content was determined by residue on baking at 150° C. for 20 minutes.

### Examples 2b to 24b and Comparative Examples 1b to 7b

Binder dispersions for a non-aqueous secondary battery separator containing polymers (A1-2b to 24b) or polymers (A3-1b to 7b) were each obtained in the same manner as in Example 1b except that the blending composition and blend quantity (parts by mass) were changed as shown in Table 1B to 3B. Note that in Examples 4b, 6b, and 12b and Comparative Example 5b, 25% aqueous ammonia was added after completion of the reaction in an equivalent molar amount to a carboxy group in the resin for neutralization.

In Examples 21b and 24b, aggregates were observed during polymerization. In addition, Comparative Examples 7b could not be synthesized due to poor polymerization stability.

Physical property values and evaluation results of the resulting polymers and binder dispersions for a non-aqueous secondary battery separator were determined by a method below. The results are shown in Table 1B to 3B.

### <Acid Value>

The acid value of the polymer is the number of milligrams of potassium hydroxide required to neutralize acidic components contained in 1 g of dried resin. According to the method described in JIS K2501, potentiometric titration was performed using an automatic titrator (“COM-A19”, manufactured by HIRANUMA Co., Ltd.) with a potassium hydroxide-ethanol solution to calculate the acid value.

### <Light Transmittance>

The resulting binder dispersion was adjusted to have a solid concentration of 5% with ion-exchanged water and placed in a quartz cell with an optical path length of 1 cm, and then a transmission spectrum thereof was measured at a wavelength of 400 nm using a spectrophotometer (“V-770”, manufactured by JASCO Corporation). The ion-exchanged water was used for comparison.
A: Light transmittance of less than 50%.
B: Light transmittance of 50% or more and less than 70%.
C: Light transmittance of 70% or more.

### <Storage Modulus>

The resulting binder dispersion was dried at 40° C. for 72 hours to make a film having a thickness of about 0.5 mm. The resulting film was cut into a strip having a size of 5 mm width×20 mm length as a sample, and the storage modulus 150° C. was measured using a dynamic viscoelasticity measuring device (“DVA-200”, manufactured by IT Keisoku Seigyo Co., Ltd.). The measurement conditions were as follows:
Measurement mode: Tensile
Frequency: 10 Hz
Strain: 0.01%
Temperature rising condition: 10° C./min
A: Storage modulus of 1.0×10⁷ Pa or more.
B: Storage modulus of 1.0×10⁶ or more and less than 1.0×10⁷ Pa.
C: Storage modulus of less than 1.0×10⁶ Pa.

### <Viscosity>

The viscosity of the resulting binder dispersion with a solid concentration of 15% was measured (temperature: 25° ° C., spindle rotation time: 60 seconds, spindle rotation speed: 20 rpm) using a B-type viscometer (“TVB10”, manufactured by Toki Sangyo Co., Ltd.).
A: Viscosity of 500 or more and less than 7,000 mPa·s.
B: Viscosity of 100 or more and less than 500 mPa·s.
B′: Viscosity of 7,000 or more and less than 15,000 mPa·s.
C: Viscosity of less than 100 mPa·s.
C′: Viscosity of 15,000 mPa·s or more.

### <Average Particle Size>

The average particle size was determined by diluting a solution of the polymer to a solid concentration of 1% by mass and measuring about 5 ml of the diluted solution by dynamic light scattering measurement (measurement device: Nanotrac UPA, manufactured by MicrotracBEL Corp). The peak of the volume particle size distribution data (histogram) obtained at this time was used as the average particle size.
A: Average particle size of 100 nm or more and less than 3,000 nm.
B: Average particle size of 3,000 nm or more and less than 4,000 nm or 10 nm or more and less than 100 nm.
C: Average particle size of less than 10 nm or 4,000 nm or more.

### <<Evaluation of Binder Dispersion>>

### <Electrolytic Solution Resistance>

Electrolytic solution resistance, the ease of dissolution and swelling of the polymer in an electrolytic solution, was evaluated by the electrolytic solution swelling degree. The smaller the electrolytic solution swelling degree, the better the electrolytic solution resistance.

The resulting binder dispersion was dried at 40° C. for 72 hours to make a film having a thickness of about 1 mm. Subsequently, the film was cut into a size of 10 mm length×10 mm width as a sample, and the sample was immersed in a mixed solvent of ethylene carbonate and diethyl carbonate in a volume ratio of 2:3 at 60° C. for 72 hours. The swelling degree of the film before and after immersion was calculated as follows:

Swelling degree(times)=(mass after immersion)/(mass before immersion)
A: Swelling degree of less than 1.5 times.
B: Swelling degree of 1.5 or more and less than 2.
C: Swelling degree of 2 times or more.

TABLE 1B

| | | | | Example | Example | Example | Example | Example | Example |
|---|---|---|---|---|---|---|---|---|---|
| | | | | 1b | 2b | 3b | 4b | 5b | 6b |
| Polymer (A) | Name | | log Kow | Polymer | Polymer | Polymer | Polymer | Polymer | Polymer |
| | | | | A1 - 1b | A1 - 2b | A1 - 3b | A1 - 4b | A1 - 5b | A1 - 6b |
| | Acrylamide | | −0.87 | 66 | 60 | 69 | 71 | 61 | 65 |
| | Methacrylamide | | 0 | | 2 | | 5 | | 6.8 |
| | Nonionic | IBA | 2.06 | | | | | | 2 |
| | monomer | BA | 2.23 | | 36 | | 5 | 25 | |
| | (a-1b) | IBMA | 2.67 | 32 | | | 16 | 12 | 25 |
| | | St | 3.06 | | | 27 | | 2 | |
| | | 2EHA | 4.01 | | | 2 | | | |
| | | 1,4-BDDMA | 2.98 | | | | | | |
| | Other | AA | 0.2 | | | | 1 | | 1.2 |
| | monomer | 2HEA | 0.01 | | | | | | |
| | (a-2) | 2HEMA | 0.7 | | 2 | 1 | | | |
| | | MMA | 1.13 | | | 1 | | | |
| | | INA | 4.44 | | | | 2 | | |
| | | 1,9-NDDA | 5.44 | 2 | | | | | |

| | Acid value (mgKOH/g) | 0.0 | 0.0 | 0.0 | 7.8 | 0.0 | 9.3 |
|---|---|---|---|---|---|---|---|
| Surfactant | 20% EMAL 2FG | 1.0 | 1.0 | 1.0 | 1.0 | 1.0 | 1.0 |
| 10% aqueous solution | | 2.0 | 2.0 | 2.0 | 2.0 | 2.0 | 2.0 |
| of ammonium persulfate | | | | | | | |
| Physical | Light transmittance | A | A | A | A | A | A |
| property | Storage modulus | A | A | A | A | A | A |
| value | Viscosity | A | A | A | A | A | A |
| | Average particle size | A | A | A | A | A | A |
| Evaluation | Electrolytic | A | A | A | A | A | A |
| | solution resistance | | | | | | |

| | | | Example | Example | Example | Example | Example |
|---|---|---|---|---|---|---|---|
| | | | 7b | 8b | 9b | 10b | 11b |
| Polymer (A) | Name | log Kow | Polymer | Polymer | Polymer | Polymer | Polymer |
| | | | A1 - 7b | A1 - 8b | A1 - 9b | A1 - 10b | A1 - 11b |
| | Acrylamide | −0.87 | 74 | 66 | 66 | 77 | 51 |
| | Methacrylamide | 0 | | | | 4 | |

| | | | | | | | |
|---|---|---|---|---|---|---|---|
| Nonionic | IBA | 2.06 | 2 | 32 | | | |
| monomer | BA | 2.23 | 20 | | | | 20 |
| (a-1b) | IBMA | 2.67 | | | | 16 | 20 |
| | St | 3.06 | | | | | 9 |
| | 2EHA | 4.01 | | | 32 | | |
| | 1,4-BDDMA | 2.98 | | | | | |
| Other | AA | 0.2 | | | | | |
| monomer | 2HEA | 0.01 | | | | | |
| (a-2) | 2HEMA | 0.7 | 3 | | | | |
| | MMA | 1.13 | 1 | | | | |
| | INA | 4.44 | | | | 3 | |
| | 1,9-NDDA | 5.44 | | 2 | 2 | | |

| | Acid value (mgKOH/g) | 0.0 | 0.0 | 0.0 | 0.0 | 0.0 |
|---|---|---|---|---|---|---|
| Surfactant | 20% EMAL 2FG | 2.0 | 1.0 | 1.0 | 1.0 | 1.0 |
| 10% aqueous solution | | 2.0 | 2.0 | 2.0 | 2.0 | 2.0 |
| of ammonium persulfate | | | | | | |
| Physical | Light transmittance | A | A | A | B | A |
| property | Storage modulus | A | A | A | A | B |
| value | Viscosity | A | B′ | B | B | B |
| | Average particle size | A | A | A | A | A |
| Evaluation | Electrolytic | A | A | A | A | B |
| | solution resistance | | | | | |

TABLE 2B

| | | | | Example | Example | Example | Example | Example | Example |
|---|---|---|---|---|---|---|---|---|---|
| | | | | 12b | 13b | 14b | 15b | 16b | 17b |
| Polymer (A) | Name | | log Kow | Polymer | Polymer | Polymer | Polymer | Polymer | Polymer |
| | | | | A1 - 12b | A1 - 13b | A1 - 14b | A1 - 15b | A1 - 16b | A1 - 17b |
| | Acrylamide | | −0.87 | 60 | 75 | 63 | 63 | 15 | 66 |
| | Methacrylamide | | 0 | 2.1 | | | | 44 | |
| | Nonionic | IBA | 2.06 | | 20 | | | | |
| | monomer | BA | 2.23 | 36 | 1 | 30 | 30 | | |
| | (a-1b) | IBMA | 2.67 | | | | | 4 | 32 |
| | | St | 3.06 | | | | | 35 | |
| | | 2EHA | 4.01 | | | 5 | 5 | | |
| | | 1,4-BDDMA | 2.98 | | | | | | |
| | Other | AA | 0.2 | 1.9 | | | | | |
| | monomer | 2HEA | 0.01 | | | | | | |
| | (a-2) | 2HEMA | 0.7 | | 3 | | | | |
| | | MMA | 1.13 | | 1 | | | | |
| | | INA | 4.44 | | | 2 | 2 | 2 | |
| | | 1,9-NDDA | 5.44 | | | | | | 2 |

| | Acid value (mgKOH/g) | 14.8 | 0.0 | 0.0 | 0.0 | 0.0 | 0.0 |
|---|---|---|---|---|---|---|---|
| Surfactant | 20% EMAL 2FG | 1.0 | 2.0 | 1.0 | 1.0 | 1.0 | 1.0 |
| 10% aqueous solution | | 2.0 | 2.0 | 2.0 | 3.5 | 2.0 | 3.5 |
| of ammonium persulfate | | | | | | | |
| Physical | Light transmittance | A | B | A | B | A | A |
| property | Storage modulus | A | A | B | C | B | B |
| value | Viscosity | A | B′ | A | B | A | B |
| | Average particle size | A | B | A | B | A | A |
| Evaluation | Electrolytic | A | A | B | B | C | B |
| | solution resistance | | | | | | |

| | | | Example | Example | Example | Example | Example |
|---|---|---|---|---|---|---|---|
| | | | 18b | 19b | 20b | 21b | 22b |
| Polymer (A) | Name | log Kow | Polymer | Polymer | Polymer | Polymer | Polymer |
| | | | A1 - 18b | A1 - 19b | A1 - 20b | A1 - 21b | A1 - 22b |
| | Acrylamide | −0.87 | 66 | 60 | 60 | 68 | 68 |
| | Methacrylamide | 0 | | 2 | 2 | 2 | 2 |

| | | | | | | | |
|---|---|---|---|---|---|---|---|
| Nonionic | IBA | 2.06 | | | | | |
| monomer | BA | 2.23 | | 36 | 36 | 28 | 28 |
| (a-1b) | IBMA | 2.67 | 32 | | | | |
| | St | 3.06 | | | | | |
| | 2EHA | 4.01 | | | | | |
| | 1,4-BDDMA | 2.98 | | | | | |
| Other | AA | 0.2 | | | | | |
| monomer | 2HEA | 0.01 | | | | | |
| (a-2) | 2HEMA | 0.7 | | 2 | 2 | 2 | 2 |
| | MMA | 1.13 | | | | | |
| | INA | 4.44 | | | | | |
| | 1,9-NDDA | 5.44 | 2 | | | | |

| | Acid value (mgKOH/g) | 0.0 | 0.0 | 0.0 | 0.0 | 0.0 |
|---|---|---|---|---|---|---|
| Surfactant | 20% EMAL 2FG | 1.0 | 1.0 | 1.0 | 0.3 | 10.0 |
| 10% aqueous solution | | 1.0 | 4.0 | 0.5 | 2.0 | 2.0 |
| of ammonium persulfate | | | | | | |
| Physical | Light transmittance | A | A | A | A | A |
| property | Storage modulus | A | B | A | A | A |
| value | Viscosity | B′ | C | C′ | A | A |
| | Average particle size | A | A | A | A | A |
| Evaluation | Electrolytic | A | B | A | A | A |
| | solution resistance | | | | | |

TABLE 3B

| | | | | | | Compar- | Compar- | Compar- |
|---|---|---|---|---|---|---|---|---|
| | | | | | | ative | ative | ative |
| | | | | Example | Example | Example | Example | Example |
| | | | | 23b | 24b | 1b | 2b | 3b |
| Polymer (A) | Name | | log Kow | Polymer | Polymer | Polymer | Polymer | Polymer |
| | | | | A1 - 23b | A1 - 24b | A3 - 1b | A3 - 2b | A3 - 3b |
| | Acrylamide | | −0.87 | 68 | 70 | 62 | 29 | 85 |
| | Methacrylamide | | 0 | 2 | | | 30 | |
| | Nonionic | IBA | 2.06 | | | | | 11 |
| | monomer | BA | 2.23 | 28 | | | | |
| | (a-1b) | IBMA | 2.67 | | | | | |
| | | St | 3.06 | | 7 | | | |
| | | 2EHA | 4.01 | | | | 2 | |
| | | 1,4-BDDMA | 2.98 | | 21 | | | |
| | Other | AA | 0.2 | | | | | |
| | monomer | 2HEA | 0.01 | | | 38 | | 2 |
| | (a-2) | 2HEMA | 0.7 | 2 | | | | 2 |
| | | MMA | 1.13 | | 2 | | 1 | |
| | | INA | 4.44 | | | | 38 | |
| | | 1,9-NDDA | 5.44 | | | | | |

| | Acid value (mgKOH/g) | 0.0 | 0.0 | 0.0 | 0.0 | 0.0 |
|---|---|---|---|---|---|---|
| Surfactant | 20% EMAL 2FG | 30.0 | 1.0 | 1.0 | 1.0 | 1.0 |
| 10% aqueous solution | | 2.0 | 2.0 | 2.0 | 2.0 | 2.0 |
| of ammonium persulfate | | | | | | |
| Physical | Light transmittance | A | A | C | A | C |
| property | Storage modulus | A | A | B | B | A |
| value | Viscosity | B′ | C′ | C | C | C′ |
| | Average particle size | A | A | C | A | C |
| Evaluation | Electrolytic | A | A | A | B | A |
| | solution resistance | | | | | |

| | | | Compar- | Compar- | Compar- | Compar- |
|---|---|---|---|---|---|---|
| | | | ative | ative | ative | ative |
| | | | Example | Example | Example | Example |
| | | | 4b | 5b | 6b | 7b |
| Polymer (A) | Name | log Kow | Polymer | Polymer | Polymer | Polymer |
| | | | A3 - 4b | A3- 5b | A3 - 6b | A3 - 7b |
| | Acrylamide | −0.87 | 48 | 58 | 77 | 68 |
| | Methacrylamide | 0 | | 2 | 4 | 2 |

| | | | | | | |
|---|---|---|---|---|---|---|
| Nonionic | IBA | 2.06 | | | 16 | |
| monomer | BA | 2.23 | | 36 | | 28 |
| (a-1b) | IBMA | 2.67 | 12 | | | |
| | St | 3.06 | 40 | | | |
| | 2EHA | 4.01 | | | | |
| | 1,4-BDDMA | 2.98 | | | | |
| Other | AA | 0.2 | | 4 | | |
| monomer | 2HEA | 0.01 | | | 4 | |
| (a-2) | 2HEMA | 0.7 | | | | 2 |
| | MMA | 1.13 | | | | |
| | INA | 4.44 | | | | |
| | 1,9-NDDA | 5.44 | | | | |

| | Acid value (mgKOH/g) | 0.0 | 31.1 | 0.0 | 0.0 |
|---|---|---|---|---|---|
| Surfactant | 20% EMAL 2FG | 1.0 | 1.0 | 1.0 | 0.0 |
| 10% aqueous solution | | 2.0 | 2.0 | 2.0 | 2.0 |
| of ammonium persulfate | | | | | |
| Physical | Light transmittance | A | A | C | — |
| property | Storage modulus | C | A | A | — |
| value | Viscosity | C | A | C′ | — |
| | Average particle size | A | A | C | — |
| Evaluation | Electrolytic | C | A | A | — |
| | solution resistance | | | | |

Abbreviations in the tables are listed below.

A Log Kow value of the ethylenically unsaturated monomer was calculated by inputting the structural formula of the ethylenically unsaturated monomer converted into Smiles notation by the YMB method (property estimation function) of Hansen solubility parameter software HSPiP (ver. 5.2.05).

<Nonionic Ethylenically Unsaturated Monomer (a-1b)>
t-BA: t-Butyl acrylate (Log Kow: 2.06)
BA: Butyl acrylate (Log Kow: 2.23)
t-BMA: t-Butyl methacrylate (log Kow: 4.01)
St: Styrene (Log Kow: 3.06)
2EHA: 2-Ethylhexyl acrylate (Log Kow: 0.82)
1,4-BDDMA: 1,4-Butanediol dimethacrylate (Log Kow: 2.98)
   <Another Ethylenically Unsaturated Monomer (a-2)>
AA: Acrylic acid (Log Kow: 0.2)
2HEA: Hydroxyethyl acrylate (Log Kow: 0.01)
2HEMA: Hydroxyethyl methacrylate (Log Kow: 0.7)
MMA: Methyl methacrylate (Log Kow: 1.13)
iNA: Isononyl acrylate (Log Kow: 4.44)
1,9-NDDA: 1,9-Nonanediol diacrylate (Log Kow: 5.44)

### Example 25

### <Preparation of Slurry Composition for Non-aqueous Secondary Battery Separator>

In a bead mill, 42.4 parts of inorganic fine particles (alumina, average particle size: 0.5 μm), 0.5 parts of ammonium polycarboxylate (BYK-154) as a dispersant, and 42.7 parts of water were fed to make a dispersion of alumina. To the resulting alumina dispersion were added 1.1 parts of a binder dispersion containing the polymer (A1-1b) in terms of solid content, 0.6 parts of a 4% aqueous solution of carboxymethyl cellulose (CMC, Daicel 1220) as a thickener, 0.3 parts of a silicon-based activating agent (BYK-349) as a wetting agent, and 0.2 parts of a silicon-based antifoaming agent (BYK-018), and water was added to the mixture so as to have a solid concentration of 43%. Then, they were mixed to make a slurry composition for a non-aqueous secondary battery separator.

### <Production of Non-aqueous Secondary Battery Separator>

The slurry composition was applied onto one surface of a separator substrate (9 μm porous polyethylene film) with a doctor blade to a thickness of 3 μm, then dried in an oven at 80° C. to obtain a separator with a protective layer.

### (Production of Positive Electrode)

A composite ink for a positive electrode was produced by adding and mixing 93 parts of LiNi_{0.5}Mn_{0.3}Co_{0.2}O₂ as a positive electrode active material, 4 parts of acetylene black as a conductive agent, 3 parts of polyvinylidene fluoride as a binder, and 45 parts of N-methylpyrrolidone. The resulting composite ink for a positive electrode was applied onto a 20 μm-thick aluminum foil serving as a current collector with a doctor blade, then dried by heating at 80° C. to adjust the weight per unit area of the electrode to 20 mg/cm². The resultant was subjected to a rolling treatment with a roll press, thereby producing a positive electrode with a composite layer having a density of 3.1 g/cm³.

A composite ink for a negative electrode was produced by kneading 98 parts of artificial graphite as a negative electrode active material and 66.7 parts of a 1.5% aqueous solution of carboxymethyl cellulose (1 part as a solid content) in a planetary mixer and mixing 33 parts of water and 2.08 parts of a 48% aqueous dispersion of a styrene-butadiene emulsion (1 part as a solid content). The resulting composite ink for a negative electrode was applied onto a 20 μm-thick copper foil serving as a current collector with a doctor blade, then dried by heating at 80° C. to adjust the weight per unit area of the electrode to 12 mg/cm². The resultant was subjected to a rolling treatment with a roll press, thereby producing a negative electrode with a composite layer having a density of 1.5 g/cm³.

### <Preparation of Non-aqueous Secondary Battery>

The positive and negative electrodes were punched to a size of 45 mm×40 mm and 50 mm×45 mm, respectively. The positive electrode and the negative electrode were inserted into an aluminum laminate bag opposite to each other via a separator with a protective layer and dried in a vacuum. Then, an electrolytic solution (non-aqueous electrolytic solution in which LiPF₆ was dissolved at a concentration of 1M in a mixed solvent of ethylene carbonate and diethyl carbonate mixed in a volume ratio of 2:3) was injected, and the aluminum laminate was sealed to produce a laminated non-aqueous secondary battery.

### Examples 26b to 48b, 52b and 53b, and Comparative Examples 8b to 14b

A slurry composition for a non-aqueous secondary battery separator, a non-aqueous secondary battery separator, and a non-aqueous secondary battery were produced in the same manner as in Example 25b, except that the composition and blend quantity (parts by mass) were changed as shown in Table 4B.

### Example 49b

In a bead mill, 42.4 parts of inorganic fine particles (alumina, average particle size: 0.5 μm), 0.5 parts of ammonium polycarboxylate (BYK-154) as a dispersant, and 42.7 parts of water were fed to make a dispersion of alumina. To the resulting alumina dispersion were added 1.0 part of a binder dispersion containing the polymer (A1-11b) in terms of solid content, 0.1 parts of a dispersion of the polymer (A2-1b) in terms of solid content, 0.6 parts of a 4% aqueous solution of carboxymethyl cellulose (CMC, Daicel 1220) as a thickener, 0.3 parts of a silicon-based activating agent (BYK-349) as a wetting agent, and 0.2 parts of a silicon-based antifoaming agent (BYK-018), and water was added to the mixture so as to have a solid concentration of 43%. Then, they were mixed to make a slurry composition for a non-aqueous secondary battery separator.

### Examples 50b and 51b

A slurry composition for a non-aqueous secondary battery separator, a non-aqueous secondary battery separator, and a non-aqueous secondary battery were produced in the same manner as in Example 49b, except that the composition and blend quantity (parts by mass) were changed as shown in Table 4B.

The resulting slurry composition for a non-aqueous secondary battery separator, the non-aqueous secondary battery separator, and the non-aqueous secondary battery were used to evaluate solution stability and coatability; adhesion of the protective layer to the separator substrate, water content, and heat resistance; and initial resistance and cycle characteristics, respectively, by methods described below. The results are shown in Table 4B.

### <<Evaluation of Slurry Composition>>

### <Solution Stability>

The slurry composition was stored at 50° C. and visually inspected for aggregation, precipitation, and separation.

### [Evaluation Criteria]

oo: No abnormality observed for four weeks or more from the start of storage. Extremely good.
o: Some abnormality observed after one week or more and less than four weeks from the start of storage. Good.
Δ: Some abnormality observed after four days or more and less than one week from the start of storage. Available.
x: Some abnormality observed within three days from the start of storage. Problem in practical use.

### <Coatability>

The slurry composition was visually observed to evaluate the coatability using the resulting separator.

### [Evaluation Criteria]

oo: Even film thickness and no cissing. Extremely good.
o: Unevenness or cissing in less than 5% of the coated portion. Good.
Δ: Unevenness or cissing in 5% or more and less than 10% of the coated portion. Available.
x: Unevenness or cissing in 10% or more of the coated portion. Problem in practical use.

### <<Evaluation of Separator>>

### <Heat Resistance of Separator>

The separator was cut into a size of 100 mm in MD (flow direction)×100 mm in TD (vertical direction) to prepare a sample. The sample was sandwiched between three sheets of paper and placed in an oven at 150° C. for two hours.

After the sample was removed from the oven and allowed to cool, the shrinkage rate was calculated as follows:

$$Sample area ( {mm}^{2} ) = ( MD length of sample ) \times ( TD length of sample )$$

$$Shrinkage ratio \text{(\%):} = [ \text{} ( sample area after heating ) / ( sample area before heating ) ] \times 100$$

### [Evaluation Criteria]

oo: Shrinkage ratio of less than 7%. Extremely good.
o: Shrinkage ratio of 7% or more and less than 15%. Good.
Δ: Shrinkage ratio of 15% or more and less than 30%. Practically available.
x: Shrinkage ratio of 30% or more. Problem in practical use.

### <Water Content of Separator>

The separator was allowed to stand for three days under the condition of a temperature of 23° C. and a humidity of 50%, and the water content extracted at a vaporization temperature of 120° C. using a vaporizer (VA-100, manufactured by Mitsubishi Chemical Corporation) was measured using a Karl Fischer moisture measuring device (CA-100, manufactured by Mitsubishi Chemical Corporation).

### [Evaluation Criteria]

oo: Water content of less than 1,500 ppm. Extremely good.
o: Water content of 1,500 ppm or more and less than 2,000 ppm. Good.
Δ: Water content of 2,000 ppm or more and less than 3,000 ppm. Practically available.
x: Water content of 3,000 ppm or more. Problem in practical use.

### <Adhesion of Protective Layer to Separator Substrate>

The resulting separator with a protective layer was cut into a size of 25 mm width x 100 mm length, and the substrate side of the separator was attached to a stainless steel plate with a double-sided tape. A scotch tape with a width of 18 mm was attached onto the protective layer side and roll-crimped at a load of 1 kg. After being allowed to stand for 24 hours under conditions of a temperature of 25° C. and a humidity of 50%, one end of the scotch tape was pulled in a direction of 180° to measure peel strength with a tensile tester (“AGS-X”, manufactured by Shimadzu Corporation) (peel rate: 10 mm/min, unit: N/18 mm width).

### [Evaluation Criteria]

oo: Peel strength of 3 N/18 mm or more. Extremely good.
o: Peel strength of 2 N/18 mm or more and less than 3 N/18 mm. Good.
Δ: Peel strength of 1.5 N/18 mm or more and less than 2 N/18 mm. Practically available.
x: Peel strength of less than 1.5 N/18 mm. Problem in practical use.

### <<Evaluation of Non-aqueous Secondary Battery>>

### <Internal Resistance>

Internal resistance was the time taken for 100 ml of air to pass through the sample and was evaluated by air permeability. The shorter the time taken, the smaller the internal resistance tends to be and the better the internal resistance. According to the method described in JIS P8117, the air permeability was measured using a Gurley type air permeability tester (“G-B3C”, manufactured by Toyo Seiki Seisaku-sho, Ltd.).

### [Evaluation Criteria]

oo: Less than 250 sec/100 ml. Extremely good.
o: 250 sec/100 ml or more and less than 270 sec/100 ml. Good.
Δ: 270 sec/100 ml or more and less than 280 sec/100 ml. Practically available.
x: 280 sec/100 ml or more. Problem in practical use.

### <Cycle Characteristics>

In a thermostatic chamber at 50° C., constant current, constant voltage charge (cut-off current: 0.6 mA) was performed at a charging current of 60 mA and an end-of-charge voltage of 4.2 V, followed by constant current discharge was performed at a discharging current of 60 mA until the end-of-charge voltage reached 3.0 V to determine an initial discharge capacity. This charge-discharge cycle was performed 200 times to calculate a discharge capacity retention rate (percentage of the tenth discharge capacity with respect to the initial discharge capacity).

The higher the discharge capacity retention ratio, the better the cycle characteristics.

### [Evaluation Criteria]

oo: Discharge capacity retention ratio of 90% or more. Extremely good.
o: Discharge capacity retention ratio of 85% or more and less than 90%. Good.
Δ: Discharge capacity retention ratio of 80% or more and less than 85%. Practically available.
x: Discharge capacity retention ratio of less than 80%. Problem in practical use.

TABLE 4B

| | Inorganic | | | | | | | | | | Non-aqueous | |
|---|---|---|---|---|---|---|---|---|---|---|---|---|
| | filler | Polymer (1) | | Polymer (2) | | | | | | | secondary battery | |
| | Blend | | Blend | | Blend | Coating agent | | Separator | | | | Cycle |
| | quantity | | quantity | | quantity | Solution | | Heat | Water | | Internal | charac- |
| | (parts) | Type | (parts) | Type | (parts) | stability | Coatability | resistance | content | Adhesion | resistance | teristics |
| Example 25b | 42.4 | Polymer | 1.1 | — | — | ∘∘ | ∘∘ | ∘∘ | ∘∘ | ∘∘ | ∘∘ | ∘∘ |
| | | (A1 - 1b) | | | | | | | | | | |
| Example 26b | 42.4 | Polymer | 1.1 | — | — | ∘∘ | ∘∘ | ∘∘ | ∘∘ | ∘∘ | ∘∘ | ∘∘ |
| | | (A1 - 2b) | | | | | | | | | | |
| Example 27b | 42.4 | Polymer | 1.1 | — | — | ∘∘ | ∘∘ | ∘∘ | ∘∘ | ∘∘ | ∘∘ | ∘∘ |
| | | (A1 - 3b) | | | | | | | | | | |
| Example 28b | 42.4 | Polymer | 1.1 | — | — | ∘∘ | ∘∘ | ∘∘ | ∘∘ | ∘∘ | ∘∘ | ∘∘ |
| | | (A1 - 4b) | | | | | | | | | | |
| Example 29b | 42.4 | Polymer | 1.1 | — | — | ∘∘ | ∘∘ | ∘∘ | ∘∘ | ∘∘ | ∘∘ | ∘∘ |
| | | (A1 - 5b) | | | | | | | | | | |
| Example 30b | 42.4 | Polymer | 1.1 | — | — | ∘∘ | ∘∘ | ∘∘ | ∘∘ | ∘∘ | ∘∘ | ∘∘ |
| | | (A1 - 6b) | | | | | | | | | | |
| Example 31b | 42.4 | Polymer | 1.1 | — | — | ∘∘ | ∘∘ | ∘∘ | ∘∘ | ∘∘ | ∘∘ | ∘∘ |
| | | (A1 - 7b) | | | | | | | | | | |
| Example 32b | 42.4 | Polymer | 1.1 | — | — | ∘∘ | ∘ | ∘∘ | ∘ | ∘∘ | ∘∘ | ∘ |
| | | (A1 - 8b) | | | | | | | | | | |
| Example 33b | 42.4 | Polymer | 1.1 | — | — | ∘∘ | ∘ | ∘ | ∘∘ | ∘ | ∘∘ | ∘ |
| | | (A1 - 9b) | | | | | | | | | | |
| Example 34b | 42.4 | Polymer | 1.1 | — | — | ∘∘ | ∘ | ∘∘ | ∘ | ∘∘ | ∘ | ∘ |
| | | (A1 - 10b) | | | | | | | | | | |
| Example 35b | 42.4 | Polymer | 1.1 | — | — | ∘∘ | ∘ | Δ | ∘∘ | Δ | ∘ | ∘ |
| | | (A1 - 11b) | | | | | | | | | | |
| Example 36b | 42.4 | Polymer | 1.1 | — | — | Δ | ∘∘ | ∘∘ | ∘∘ | ∘∘ | ∘∘ | ∘ |
| | | (A1 - 12b) | | | | | | | | | | |
| Example 37b | 42.4 | Polymer | 1.1 | — | — | ∘∘ | ∘ | ∘∘ | ∘ | ∘∘ | Δ | ∘ |
| | | (A1 - 13b) | | | | | | | | | | |
| Example 38b | 42.4 | Polymer | 1.1 | — | — | ∘∘ | ∘∘ | ∘ | ∘∘ | ∘ | ∘ | ∘ |
| | | (A1 - 14b) | | | | | | | | | | |
| Example 39b | 42.4 | Polymer | 1.1 | — | — | ∘ | ∘ | Δ | ∘∘ | Δ | ∘ | Δ |
| | | (A1 - 15b) | | | | | | | | | | |
| Example 40b | 42.4 | Polymer | 1.1 | — | — | ∘∘ | ∘∘ | ∘ | ∘∘ | ∘ | Δ | ∘ |
| | | (A1 - 16b) | | | | | | | | | | |
| Example 41b | 42.4 | Polymer | 1.1 | — | — | ∘∘ | ∘ | ∘ | ∘∘ | ∘ | ∘∘ | ∘ |
| | | (A1 - 17b) | | | | | | | | | | |
| Example 42b | 42.4 | Polymer | 1.1 | — | — | ∘∘ | ∘ | ∘∘ | ∘∘ | ∘∘ | ∘∘ | ∘ |
| | | (A1 - 18b) | | | | | | | | | | |
| Example 43b | 42.4 | Polymer | 1.1 | — | — | ∘∘ | Δ | Δ | ∘∘ | Δ | ∘∘ | Δ |
| | | (A1 - 19b) | | | | | | | | | | |
| Example 44b | 42.4 | Polymer | 1.1 | — | — | ∘∘ | Δ | ∘∘ | ∘∘ | ∘∘ | ∘∘ | ∘ |
| | | (A1 - 20b) | | | | | | | | | | |
| Example 45b | 42.4 | Polymer | 1.1 | — | — | | ∘∘ | ∘∘ | ∘∘ | ∘∘ | ∘∘ | ∘ |
| | | (A1 - 21b) | | | | | | | | | | |
| Example 46b | 42.4 | Polymer | 1.1 | — | — | ∘∘ | ∘∘ | ∘∘ | Δ | ∘∘ | Δ | ∘ |
| | | (A1 - 22b) | | | | | | | | | | |
| Example 47b | 42.4 | Polymer | 1.1 | — | — | ∘∘ | ∘∘ | ∘∘ | Δ | ∘∘ | Δ | Δ |
| | | (A1 - 23b) | | | | | | | | | | |
| Example 48b | 42.4 | Polymer | 1.1 | — | — | Δ | Δ | ∘∘ | ∘∘ | Δ | ∘ | Δ |
| | | (A1 - 24b) | | | | | | | | | | |
| Example 49b | 42.4 | Polymer | 1 | Polymer | 0.1 | ∘∘ | ∘ | Δ | ∘∘ | ∘ | ∘ | ∘ |
| | | (A1 - 11b) | | (A2 - 1b) | | | | | | | | |
| Example 50b | 42.4 | Polymer | 0.6 | Polymer | 0.5 | ∘∘ | ∘ | Δ | ∘∘ | ∘ | ∘ | ∘ |
| | | (A1 - 11b) | | (A2 - 1b) | | | | | | | | |
| Example 51b | 42.4 | Polymer | 0.35 | Polymer | 0.75 | ∘∘ | ∘ | Δ | ∘∘ | ∘∘ | ∘ | Δ |
| | | (A1 - 11b) | | (A2 - 1b) | | | | | | | | |
| Example 52b | 42.4 | Polymer | 0.8 | — | — | ∘∘ | ∘∘ | ∘∘ | ∘∘ | ∘∘ | ∘∘ | ∘∘ |
| | | (A1 - 1b) | | | | | | | | | | |
| Example 53b | 42.4 | Polymer | 1.5 | — | — | ∘∘ | ∘∘ | ∘∘ | ∘∘ | ∘∘ | ∘∘ | ∘∘ |
| | | (A1 - 1b) | | | | | | | | | | |
| Comparative | 42.4 | Polymer | 1.1 | — | — | ∘∘ | Δ | ∘∘ | Δ | ∘∘ | Δ | x |
| Example 8b | | (A3 - 1b) | | | | | | | | | | |
| Comparative | 42.4 | Polymer | 1.1 | — | — | ∘∘ | Δ | Δ | ∘∘ | Δ | ∘∘ | x |
| Example 9b | | (A3 - 2b) | | | | | | | | | | |
| Comparative | 42.4 | Polymer | 1.1 | — | — | ∘∘ | Δ | ∘∘ | x | ∘∘ | × | Δ |
| Example 10b | | (A3 - 3b) | | | | | | | | | | |
| Comparative | 42.4 | Polymer | 1.1 | — | — | ∘∘ | Δ | x | ∘∘ | x | ∘ | x |
| Example 11b | | (A3 - 4b) | | | | | | | | | | |
| Comparative | 42.4 | Polymer | 1.1 | — | — | x | x | Δ | ∘ | Δ | ∘ | x |
| Example 12b | | (A3 - 5b) | | | | | | | | | | |
| Comparative | 42.4 | Polymer | 1.1 | — | — | ∘∘ | Δ | ∘∘ | Δ | ∘∘ | x | Δ |
| Example 13b | | (A3 - 6b) | | | | | | | | | | |
| Comparative | 42.4 | Polymer | 1.1 | — | — | x | ∘ | x | ∘∘ | ∘ | ∘ | x |
| Example 14b | | (A2 - 1b) | | | | | | | | | | |

As shown in Table 4A, it was confirmed that a binder dispersion for a non-aqueous secondary battery separator of Examples, the binder dispersion including a polymer (A1b), a surfactant, and an aqueous medium, in which the polymer (A1b) was a polymer of 50 to 85% by mass of (meth)acrylamide and 15 to 50% by mass of a nonionic ethylenically unsaturated monomer (a-1b) having an octanol/water partition coefficient logarithm (Log Kow) of 1.9 to 4.2 at 25° C. based on a total mass of the ethylenically unsaturated monomer and had an acid value of 15 mgKOH/g or less; and light transmittance at a wavelength of 400 nm was less than 70% under the condition of a solid concentration of 5%, was used to form a slurry composition which had good solution stability and coatability, and a secondary battery separator which was excellent in heat resistance and adhesion, and a secondary battery which had small internal resistance and excellent cycle characteristics. On the other hand, Comparative Example 7, which did not contain any surfactant, was significantly inferior in polymerization stability. The slurry compositions for a non-aqueous secondary battery separator, the non-aqueous secondary battery separator, and the non-aqueous secondary battery using Comparative Examples 1b to 6b or without the polymer (A1b) were also extremely inferior in any of the physical properties, and the results were far from meeting the level of practical use.

This application claims the priority based on Japanese Patent Application No. 2021-91136 filed on May 31, 2021, and Japanese Patent Application No. 2022-1818 filed on Jan. 7, 2022, the disclosures of which are incorporated herein in their entirety.

1-10. (canceled)

11. A binder dispersion for a non-aqueous secondary battery separator, the binder dispersion comprising:
a polymer (A1); and
an aqueous medium, wherein
the polymer (A1) has an acid value of 15 mgKOH/g or less and is a polymer (A1a) of an ethylenically unsaturated monomer mixture containing 40 to 80% by mass of (meth)acrylamide and 20 to 60% by mass of a nonionic ethylenically unsaturated monomer (a-1a) having an octanol/water partition coefficient logarithm (Log Kow) of 0.25 to 1.5 at 25° C. based on a total mass of the ethylenically unsaturated monomer mixture, and
light transmittance at a wavelength of 400 nm is less than 70% under a condition of a solid concentration of 5% by mass.

12. A binder dispersion for a non-aqueous secondary battery separator, the binder dispersion comprising:
a polymer (A1);
a surfactant; and
an aqueous medium, wherein
the polymer (A1) has an acid value of 15 mgKOH/g or less and is a polymer (A1b) of an ethylenically unsaturated monomer mixture containing 50 to 85% by mass of (meth)acrylamide and 15 to 50% by mass of a nonionic ethylenically unsaturated monomer (a-1b) having an octanol/water partition coefficient logarithm (Log Kow) of 1.9 to 4.2 at 25° C. based on a total mass of the ethylenically unsaturated monomer mixture, and
light transmittance at a wavelength of 400 nm is less than 70% under a condition of a solid concentration of 5% by mass.

13. The binder dispersion for a non-aqueous secondary battery separator according to claim 11, wherein the polymer (A1) has a storage modulus of 1.0×10⁶ Pa or more at 150° C.

14. The binder dispersion for a non-aqueous secondary battery separator according to claim 11, wherein the polymer (A1) has an electrolytic solution swelling degree of less than 2 times when immersed in a mixed solvent of ethylene carbonate and diethyl carbonate in a volume ratio of 2:3 at 60° C. for 72 hours.

15. The binder dispersion for a non-aqueous secondary battery separator according to claim 11, wherein the binder dispersion has a viscosity of 2,500 mPa·s or more and less than 25,000 mPa·s at a solid concentration of 15% by mass.

16. The binder dispersion for a non-aqueous secondary battery separator according to claim 11, wherein the binder dispersion has a viscosity of 100 mPa·s or more and less than 15,000 mPa·s at a solid concentration of 15% by mass.

17. A slurry composition for a non-aqueous secondary battery separator, the slurry composition comprising an inorganic fine particle and the binder dispersion for a non-aqueous secondary battery separator according to claim 11.

18. The slurry composition for a non-aqueous secondary battery separator according to claim 17, the slurry composition further comprising a polymer (A2) but excluding the polymer (A1),
wherein the polymer (A2) is a particulate polymer having a glass transition temperature of −40 to 40° C.

19. A non-aqueous secondary battery separator comprising a protective layer formed from the slurry composition for a non-aqueous secondary battery separator according to claim 17 on at least one surface of a separator substrate.

20. A non-aqueous secondary battery comprising the non-aqueous secondary battery separator according to claim 19.

21. The binder dispersion for a non-aqueous secondary battery separator according to claim 12, wherein the polymer (A1) has a storage modulus of 1.0×10⁶ Pa or more at 150° C.

22. The binder dispersion for a non-aqueous secondary battery separator according to claim 12, wherein the polymer (A1) has an electrolytic solution swelling degree of less than 2 times when immersed in a mixed solvent of ethylene carbonate and diethyl carbonate in a volume ratio of 2:3 at 60° C. for 72 hours.

23. The binder dispersion for a non-aqueous secondary battery separator according to claim 12, wherein the binder dispersion has a viscosity of 2,500 mPa·s or more and less than 25,000 mPa·s at a solid concentration of 15% by mass.

24. The binder dispersion for a non-aqueous secondary battery separator according to claim 12, wherein the binder dispersion has a viscosity of 100 mPa·s or more and less than 15,000 mPa·s at a solid concentration of 15% by mass.

25. A slurry composition for a non-aqueous secondary battery separator, the slurry composition comprising an inorganic fine particle and the binder dispersion for a non-aqueous secondary battery separator according to claim 12.

26. The slurry composition for a non-aqueous secondary battery separator according to claim 25, the slurry composition further comprising a polymer (A2) but excluding the polymer (A1),
wherein the polymer (A2) is a particulate polymer having a glass transition temperature of −40 to 40° C.

27. A non-aqueous secondary battery separator comprising a protective layer formed from the slurry composition for a non-aqueous secondary battery separator according to claim 25 on at least one surface of a separator substrate.

28. A non-aqueous secondary battery comprising the non-aqueous secondary battery separator according to claim 27.
